(19) United States
(12) Patent Application Publication
(10) Pub. No.: US 2011/0142335 A1
(43) Pub. Date: Jun. 16, 2011

(54) Image Comparison System and Method

(76) Inventors: Bernard Ghanem, Champaign, IL (US); Sanketh Shetty, Urbana, IL (US); Esther Resendiz, Champaign, IL (US)

(21) Appl. No.: 12/636,429

(22) Filed: Dec. 11, 2009

(51) Int. Cl. G06K 9/68

(52) U.S. Cl. 382/165; 382/218

(57) ABSTRACT

An image comparison system includes a memory unit that stores data representative of target apparel images that depict apparel items. An image processing unit is provided to process a query apparel image to extract data representative of a query apparel item depicted in the query apparel image. The image processing unit determines weighted color and pattern differences between the target apparel images and the query apparel image.

### CROSS REFERENCE TO RELATED APPLICATIONS

Not applicable

### REFERENCE REGARDING FEDERALLY SPONSORED RESEARCH OR DEVELOPMENT

Not applicable

### SEQUENTIAL LISTING

Not applicable

### BACKGROUND OF THE INVENTION

1. Field of the Invention

The present invention generally relates to systems and methods for comparing electronic images, more particularly, the present invention relates to systems and methods for comparing and storing images of apparel items including segmenting an image of an apparel item, normalizing an image of an apparel item, and developing apparel pattern filters.

2. Description of the Background of the Invention

There are many systems that query stored electronic images in a database. Traditional image query systems process text-based user specified requests for information from a database that includes images associated with preexisting meta-data. This type of image querying system is commonly found embedded in internet shopping sites where a user specifies a category, subcategory, specific search term, and/or a combination of these inputs in a query and submits the query request to a host server that responds by sending a collection of thumbnail images of consumer items that match the parameters of the user's query request.

In addition to text-based query systems, more sophisticated systems incorporate image recognition algorithms to process images and extract visually descriptive information from the images. The extracted image data is then stored in a database as meta-data associated with an image. Implementing image recognition algorithms allows systems to query data associated with images based on visually descriptive properties of the images themselves. Systems employing such image recognition algorithms are typically configured to recognize colors, patterns, and shapes in images.

Several methods for comparing images have incorporated programmatic analysis of images stored on a database. One example of an image comparison system includes an image characterizer module that determines general characteristics of an image including the colors present in an image and a search engine that determines similarity measurements of color characteristics between different images. This image comparison system further describes a method for performing localized comparisons of colors present in a particular area of an image with the colors of a corresponding area of another image. However, this image comparison system does not account for any patterns or spatial features depicted in images or the shapes of items depicted in the image when computing the similarity of different images.

Another example of an image comparison system and method includes a query engine, a computer display device, and a user interface for processing an image query for accessing images in a database. This image query system and method further includes querying for an image in a database by specifying one or more visual characteristics of the image including: image color(s), image shape(s), image texture(s), and keywords associated with an image. This image query system and method also includes a process for executing the image query by determining the similarity between the image and the specified query parameters. This image query system and method uses general parameters to describe texture including coarseness, contrast, and directionality. However, this image query system is limited in its ability to identify patterns, specifically including apparel patterns that may be depicted in images of apparel items.

In another example, a system and method for enabling image searching using manual enrichment, classification, and segmentation includes an image analysis module configured to analyze images in a collection of images and a manual interface enabling human editors to correct errors made by the image analysis module. This system and method includes processes for programmatic detection and identification of types and classes of objects depicted in images. These identifiable types and classes particularly concern types and classes of apparel items. This system and method further includes processes for image segmentation, image alignment, and identifying texture features of an apparel item. However, the image alignment process in the current example does not disclose identifying scale invariant measurements of apparel item features. Furthermore, the process for identifying texture features is also limited in that it only describes using convolution filters and Gabor filters to determine basic apparel patterns.

### BRIEF SUMMARY OF THE INVENTION

One or more of the embodiments of the present invention provide a system for comparing images of apparel items including an image comparison system, an apparel image normalization system, an apparel image segmentation system, a method of extracting data representative of the visual characteristics of an image, and a pattern filter development system. Data representative of the visual features of images are compared and stored in the image comparison system. The image comparison system identifies the category the image belongs to, and either determines the color difference, the weighted color and pattern difference, or the weighted shape and color difference. In the method of extracting the visual characteristics, data representative of the visual features of an image is extracted by the image comparison system and stored in an electronic memory medium. In the method of extracting visual characteristics, an image processing computer determines pyramid histograms of oriented gradients representative of an images shape features, a histogram representative of the objects color features, and a histogram representative of an objects pattern features.

Images of apparel items are partitioned by the apparel image segmentation system and separated into pixel sections including: an apparel foreground pixel segment, a humanoid model pixel segment, and a background pixel segment. The apparel foreground segment isolates the pixels of the original image that represent the apparel item itself. The humanoid model image segment isolates the portion of the original image depicting any human or mannequin model. The background image segment isolates the background of the original image.

The apparel image normalization system identifies scale invariants within an apparel image in order to formulate scale invariant measurements of the apparel item depicted in the image. These normalized measurements may include, for example, apparel feature measurements of the apparel item itself such as a dress length, sleeve length, width profile, and apparel patterns. The apparel data is used by the system for comparing apparel items depicted in different images.

The pattern filter development system produces apparel-specific pattern filters developed from a data set of sample apparel patterns. The apparel patterns are sampled from actual images depicting apparel items. This data set of apparel patterns are then represented in vector format and processed through a vector quantization algorithm to produce a variable number of original apparel-specific image pattern filters. The original apparel pattern filters are used by the system to extract apparel pattern data from apparel images, which is used to compute the similarity between apparel patterns of apparel items that are depicted in different apparel images.

### BRIEF DESCRIPTION OF THE DRAWINGS

FIG. 1 illustrates a system for comparing images and storing data representative of the images in a database;

FIG. 2 illustrates a pattern filter development system according to an embodiment of the present invention;

FIG. 3 is a flowchart that illustrates a process that may be executed to determine whether an electronic image is patterned;

FIG. 4 is a flowchart that illustrates a process that may be executed to segment a foreground of an electronic image;

FIG. 5 illustrates an electronic image according to an embodiment of the present invention;

FIG. 6 is a flowchart that illustrates a process that may be executed to extract spatial and color characteristics of an object depicted in an electronic image;

FIG. 7 is a flowchart that illustrates a process that may be executed to compare visual characteristics of a new electronic image with electronic images represented by data stored in a database, to store the new electronic image in the database, and to reorient the database to account for the new image;

FIG. 8 is a flowchart that illustrates a process that may be executed to determine a background and a foreground of an electronic image and to extract the foreground from the image;

FIG. 9 is a flowchart that illustrates a process that may be executed to determine color characteristics of an object depicted on an electronic image;

FIG. 10 is a flowchart that illustrates a process that may be executed to compare color characteristics of an object depicted by an electronic image with another object depicted by an electronic image;

FIG. 11 is a flowchart that illustrates a process that may be executed to develop and use pattern filters;

FIG. 12 is a flowchart that illustrates a process that may be executed to extract pattern and color characteristics of an object depicted in an electronic image;

FIG. 13 is a flowchart that illustrates a process that may be executed to determine weighted differences between visual characteristics of objects depicted by electronic images;

FIG. 14 is a flowchart that illustrates a process that may be executed to normalize a structural dimension of an object depicted by an electronic image;

FIG. 15 is another flowchart that illustrates a process that may be executed to compare visual characteristics of a new electronic image with electronic images represented by data stored in a database, to store the electronic image in the database, and to reorient the database to account for the new image;

FIG. 16 illustrates a segmented electronic image according to an embodiment of the present invention;

FIG. 17 illustrates an edge detection image according to an embodiment of the present invention; and

FIG. 18 illustrates an image segmenting system according to an embodiment of the present invention.

### DETAILED DESCRIPTION OF THE INVENTION

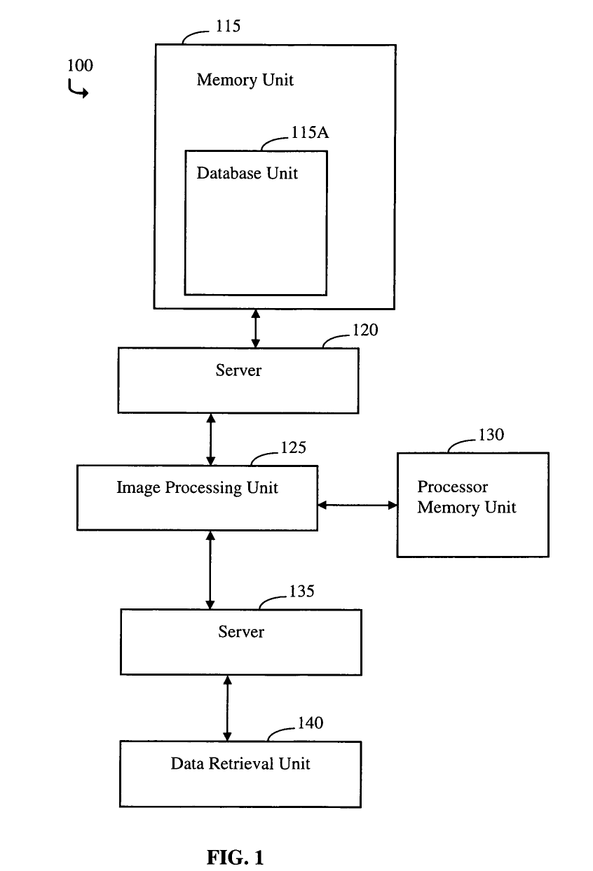

FIG. 1 illustrates a block diagram for a system 100 for comparing images. The system 100 includes a memory unit 115, a database unit 115A, a server 120, an image processing unit 125, a processor memory unit 130, a server 135, and a data retrieval unit 140.

The memory unit 115 and the database unit 115A are in bidirectional communication with the server 120. The image processing unit 125 is in bidirectional communication with the processor memory unit 130, the server 120, and the server 135. The data retrieval unit 140 is in bidirectional communication with the server 135.

The data retrieval unit 140 of the present embodiment is a web crawler that scans or browses the Internet to find a plurality of electronic images of advertised items, URL's of the electronic images, and/or any text-based data associated with the electronic images. For purposes of the present embodiment, the advertised items are items of apparel and the text-based data includes a price, a category, and a name of each of the advertised items depicted adjacent the electronic image. The data retrieval unit 140 retrieves an electronic image of the advertised item and sends data representative of the electronic image to the image processing unit 125. The image processing unit 125 may be a microprocessor, a central processing unit (“CPU”), or any other known programmable computing device.

The image processing unit 125 retrieves and executes programming instructions from the memory unit 115 and/or the processor memory unit 130. The programming instructions enable the image processing unit 125 to determine visual properties or characteristics of electronic images and to compare visual properties representative of different electronic images. The processor memory unit 130 may be ROM, RAM, or any other memory device.

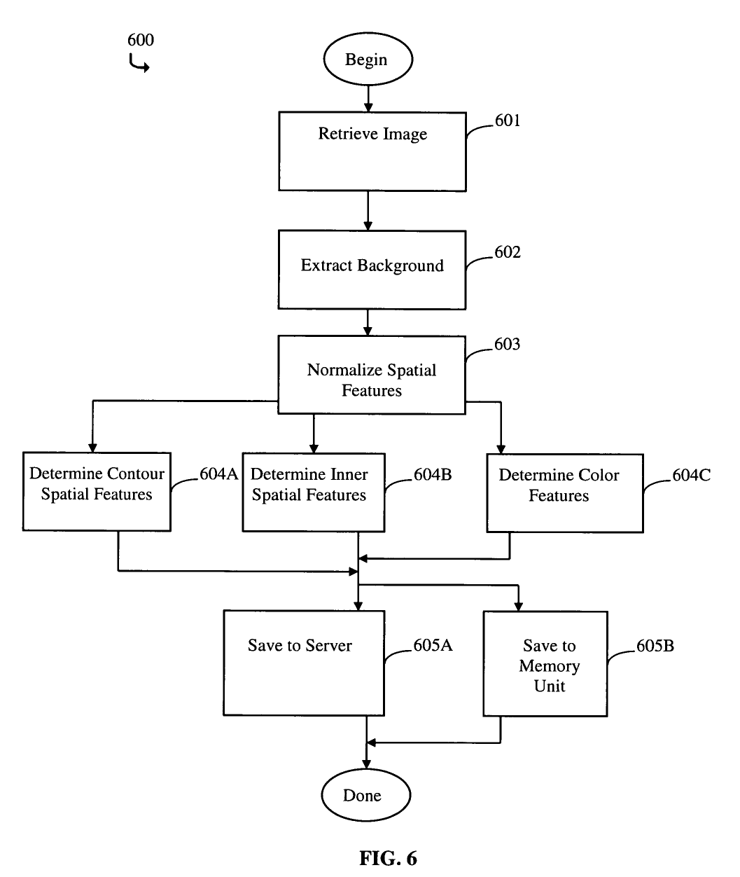

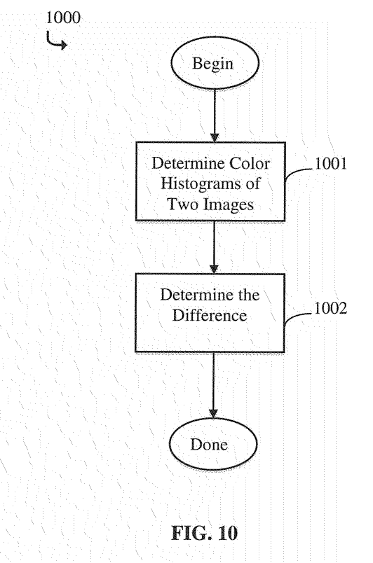

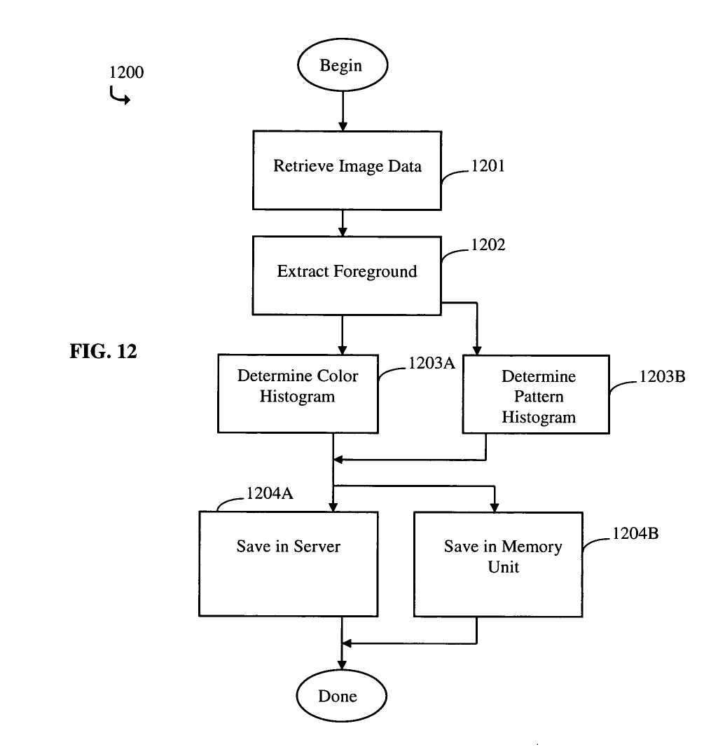

The image processing unit 125 executes programming to retrieve data representative of an electronic image depicting an object and any other data associated with the object, such as a category and name, from the data retrieval unit 140 and determines data or values representative of the visual characteristics of the object. In one embodiment, the object is an advertised apparel item. For example, if the category of the object is a dress, the image processing unit 125 determines the visual characteristics of the object in accordance to the process of FIG. 12. Further, if the category of the object is a shoe or a handbag, the image processing unit 125 determines the object's visual characteristics in accordance to the process of FIG. 6. Still further, the image processing unit 125 may determine the visual characteristics of the object in accordance to the process of FIG. 10. The image processing unit 125 sends the data representative of the visual characteristics of the object to the memory unit 115 through the server 120. The image processing unit 125 also sends data representative of the image's URL and any text based data associated with the image to the memory unit 115 through the server 120. In one embodiment of the invention, text-based data associated with the image includes the image category, the name of the image, and the price of the item depicted on the image. The image categories may include apparel items such as shoes, handbags, dresses, etc. The memory unit 115 stores this data in the database 115A.

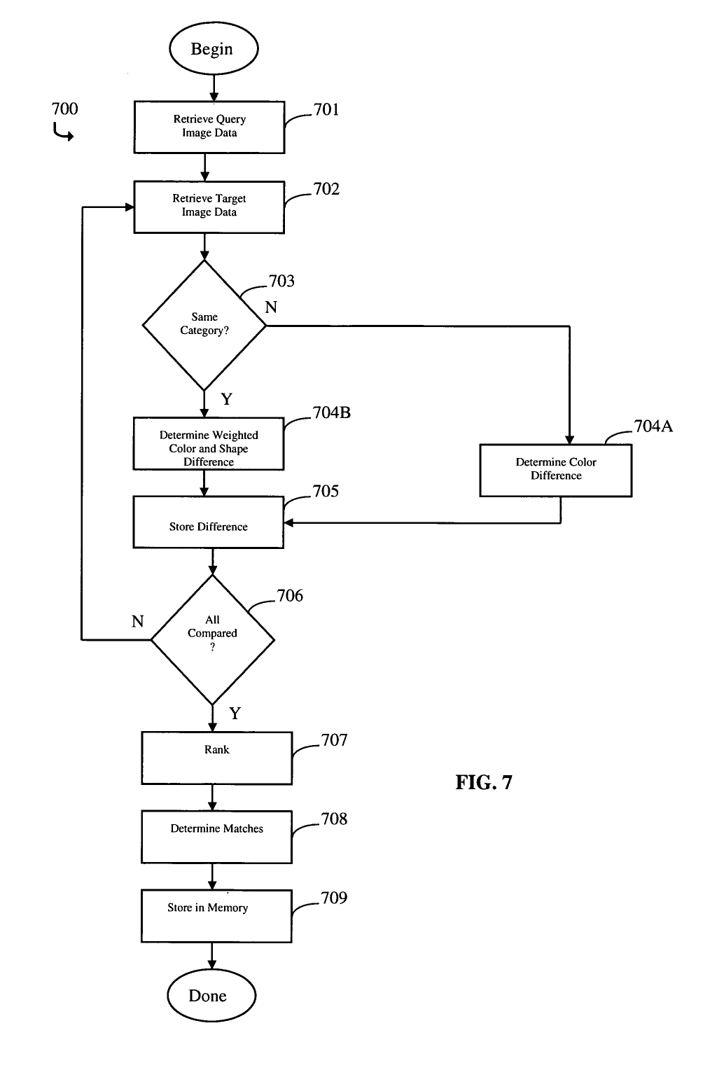

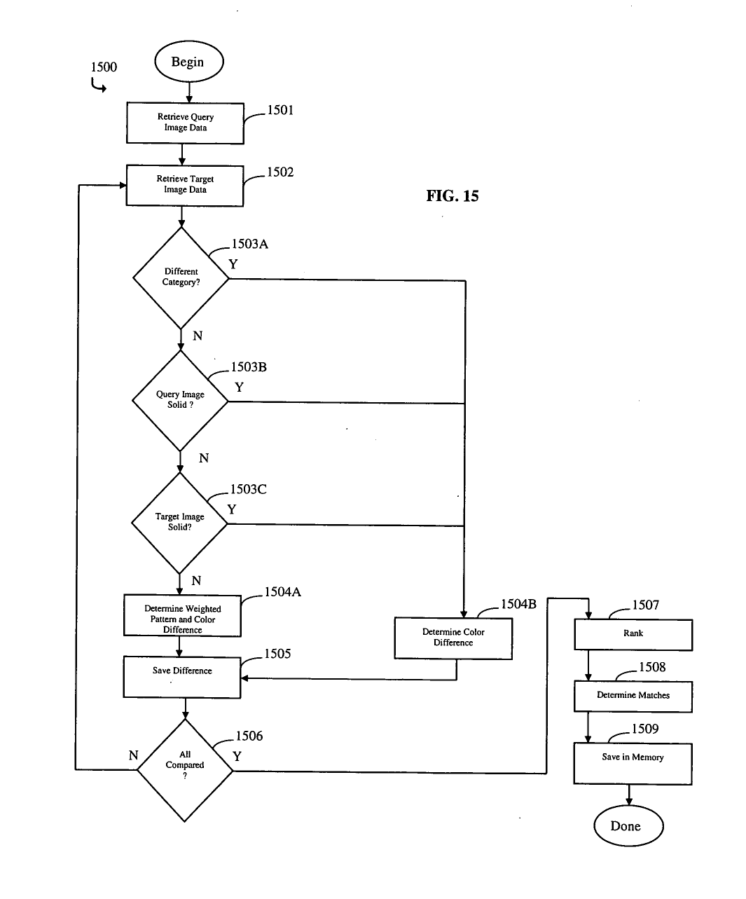

The image processing unit 125 also communicates to the memory unit 115 to determine whether there is data representative of the visual characteristics of additional images stored in the database 115A. When it is determined that data representative of additional images is stored in the database 115A, the image processing unit 125 retrieves visual data representative of a different image and determines a value representative of the difference between the visual characteristics of the images in accordance to the process of FIG. 7. Alternatively, the image processing unit 125 determines the difference in accordance to the method of FIG. 15.

In one embodiment, the processor compares the category of a target image with a query image. When the query image is in a different category than the target image the image processing unit determines a value representative of a color difference between the images in accordance to the process of FIG. 10. When the query object is categorized in the same category as the target object, the data processing unit determines a weighted difference including a color difference, as will be described in more detail hereinafter. For example, when the category of the query image and the target image is a dress, the image processing unit determines a value representative of a weighted difference of the color and pattern characteristics in accordance to the process of FIG. 12. In another example, when the query image and the target image are both shoes or handbags, the data processing unit determines a value representative of the weighted difference of the visual characteristics in accordance to the process of FIG. 6.

The image processing unit 125 then sends the value representative of the difference between the query image and the target image to the database 115A through the server 120. In another embodiment, the database 115A is in bidirectional communication with the image processing unit 125 and the image processing unit 125 sends the value without transmitting the data through the server 120. For example, the image processing unit 125 can be in communication with the memory unit 115 through a data cable such as a USB, USB 2.0, mini USB, FireWire 400, FireWire 800, or other data cable connection. Alternatively, the image processing unit 125 may be in communication with the memory unit 115 by a variety of wireless protocols, such as a WIFI communication link. Once the value is received by the database 115A, the value is saved as metadata associated with both images in the database 115A.

In a further example, the image processing unit 125 ranks the differences between images in accordance to the process of FIG. 15 or FIG. 7. In one embodiment, the image processing unit 125 stores this ranking as metadata in the database 115A. In addition, the image processing unit 125 determines which images are matches with other images. For example, if the difference between two images is small, the image processing unit 125 may determine that the images should be grouped together. A discussion of how the images are matched is further discussed in the description of FIG. 7 and FIG. 15.

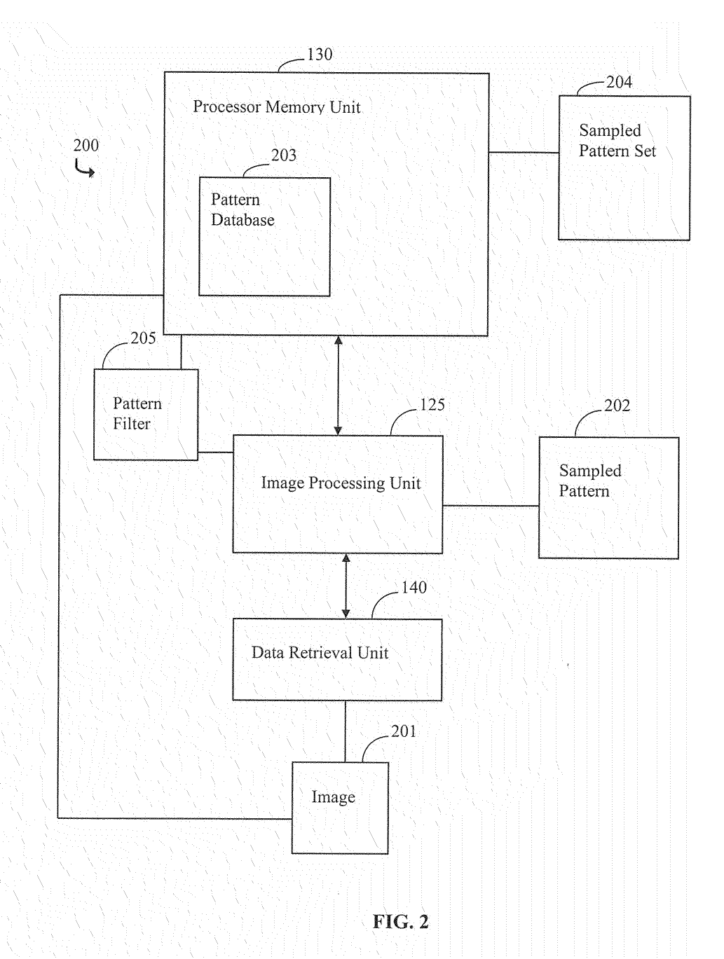

FIG. 2 illustrates a pattern filter development system 200, which includes an image processing unit 125, a processor memory unit 130, a data retrieval unit 140, an image 201, a sampled pattern 202, a pattern database 203, a pattern set 204, and a pattern filter 205. The image 201 preferably depicts an object, which may also include a background and a foreground depicting the object. Preferably, the object comprises an apparel item. In an alternative preferred embodiment, the image 201 includes a background and a foreground depicting a human, human limb, mannequin, or a limb of a mannequin wearing an apparel item. An apparel item may comprise clothing such as shoes, handbags, or dresses.

The image 201 is stored on the processor memory unit 130. The processor memory unit 130 is in bidirectional communication with the image processing unit 125, wherein the image processing unit 125 receives data representative of the image 201 from the processor memory unit 130. The image processing unit 125 is also in bidirectional communication with the data retrieval unit 140, which may also receive an electronic signal representative of the image 201. Further, the image processing unit 125 is in bidirectional communication with the pattern database 203, within the processor memory unit 130. In an alternative embodiment of the invention, the pattern database 203 is not a part of the processor memory unit 130 and the pattern database 203 is in direct communication with the image processing unit 125. The image processing unit 125 sends a signal containing the sampled pattern 202 to the pattern database 203. The image processing unit 125 also receives the pattern set 204 from the pattern database 203, wherein the pattern set 204 comprises a plurality of the sampled patterns 202. The image processing unit 125 also outputs the pattern filter 205 and stores the pattern filter 205 in the pattern database 203.

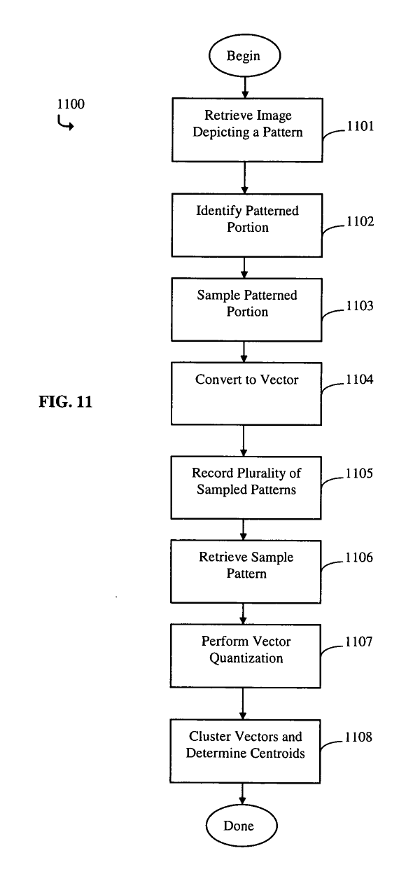

In operation, the image processing unit 125 receives the image 201 from the data retrieval unit 140. Alternatively, the image processing unit may retrieve the image 201 from the pattern database 203. After receiving the image 201, the image processing unit 125 processes the image 201 and stores the sampled pattern 202 in the pattern database 203. The image processing unit 125 then receives the pattern set 204 from the pattern database 203. The image processing unit 125 then processes the pattern set 204 and determines a new pattern filter 205. The process of developing a pattern filter 205 from the image 201 is illustrated in the flow chart of FIG. 11.

In a preferred embodiment, the processor memory unit 130 is in bidirectional communication with the image processing unit 125. In this embodiment, the image processing unit 125 sends data to the processor memory unit 130, whereby the processor memory unit 130 responds by sending data representative of the image 201 to the image processing unit 125. In another preferred embodiment, the image processing unit 125 communicates remotely with the processor memory unit 130. In this embodiment, the communication may be conducted over an Internet connection through a server. The communication between the image processing unit 125 and the processor memory unit 130 may also be conducted through a wireless connection. In another embodiment, communication may be conducted locally by connecting the processor memory unit 130 to the image processing unit 125 directly by a data cable such as a USB, USB 2.0, mini USB, FireWire 400, FireWire 800, or other data cable connection. Alternatively, the processor memory unit 130 may comprise a portable recordable media. The portable recordable media may be received directly by the image processing unit 125 and may comprise one or more recordable media for storing the image 201. In another embodiment, processor memory unit 130 consists of a plurality of servers hosting web content that are also in bidirectional communication with the pattern database 203. In such an embodiment, the processor memory unit 130 encompasses servers hosting web content of e-commerce internet sites. In another embodiment, the image processing unit 125 may include one computer that performs the process of sampling the image 201. In another embodiment, the pattern database unit 203 may be stored locally within the image processing unit 125. In another embodiment, the image processing unit 125 may include a plurality of computers that collectively perform the process of sampling the image 201. In another embodiment, the image processing unit 125 may include one computer that performs the process of vector quantization of the pattern set 204. In another embodiment, the image processing unit 125 may include a plurality of computers that collectively perform the process of vector quantization of the pattern set 204. In another embodiment, the image processing unit 125 may include only one computer that performs both the process of sampling the image 201 and the process of vector quantization of the pattern set 204. In yet another embodiment, the image processing unit 125 develops a plurality of pattern filters 205. In another embodiment the image processing unit 125 records the pattern filter 205 on the database 115A. In still another embodiment, the pattern filter 205 is used to determine the presence of a pattern in an image depicting an apparel item.

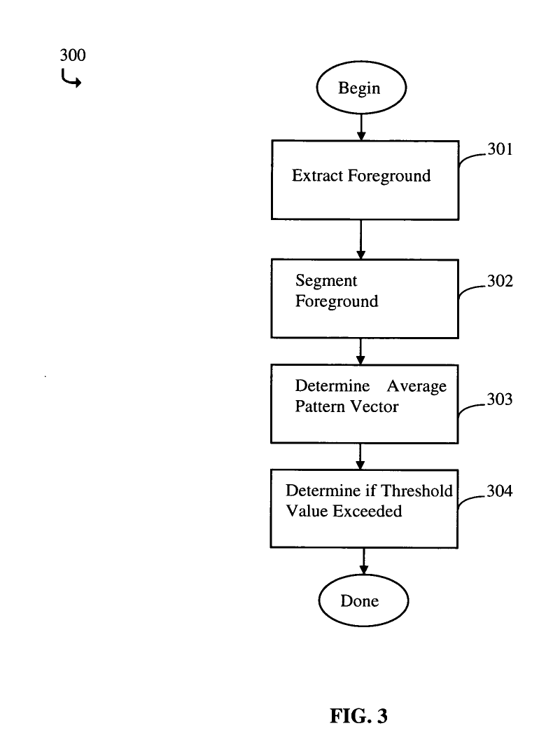

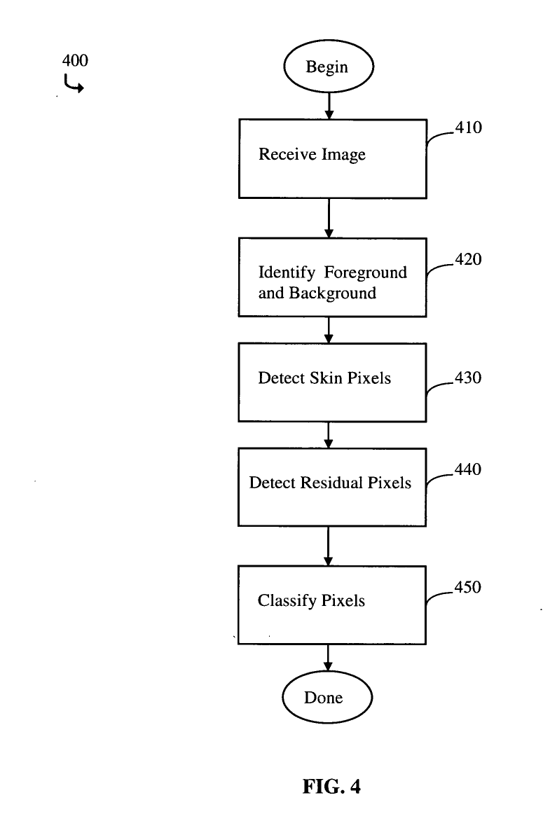

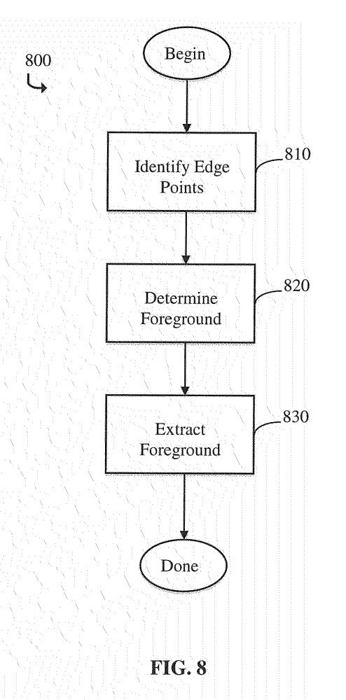

FIG. 3 illustrates a flowchart 300 of a method of determining whether an image is patterned. In step 301, the image processing unit 125 extracts the foreground of an image in accordance to the method of FIG. 8. In step 302 the image processing unit 125 segments the foreground in accordance to the method in FIG. 4. Once the foreground is segmented, the image processing unit 125 determines an average pattern vector in accordance to the description of FIG. 11 in step 303. The average pattern vector is a multi dimensional vector having vector components representative of the average convolution of each point in the image and a particular pattern filter vector. In a preferred embodiment of the invention, each point is associated with a pixel in the foreground of the image.

After the average pattern vector of the image is determined, the image processing unit determines if a component of the image's average pattern vector is above a threshold value in step 304. In one embodiment of the invention, the threshold value is determined by constructing a training set and grouping images within the training set in the classes of patterned and solidly colored images. The average pattern vector of each of the images is determined in accordance with the description to FIG. 11. All of the components of each average pattern vector are analyzed and the threshold value is determined as the threshold vector component such that the images are grouped within their predetermined classes.

In a preferred embodiment of the invention, the threshold value is obtained by first determining the average pattern vectors from a set of patterned images. Assuming that the components of the average pattern vectors have a Gaussian distribution over an infinitely large set of convolution responses to pattern filters, a probability distribution function is obtained for each vector component from the set of average pattern vectors. Particularly, each distribution function corresponds to a convolution response of a particular pattern filter vector. For each of the distribution functions, the convolution response representative of two standard deviations below the mean is determined. The distribution function having the lowest convolution response of two standard deviations below the mean is identified, and this value representative of two standard deviations below the mean is defined as the threshold value.

In an alternative embodiment of the invention, training sets are used to determine the threshold value. For example, assume that four average pattern vectors are determined that are representative of four different images, A, B, C and D, respectively. Images A and B are grouped under the class of solidly colored images, and C and D are grouped under the class of patterned images. The threshold value is determined as the largest vector component within the average pattern vectors of images A and B. This value is set as the threshold value because it is the largest value such that images A and B are grouped as solidly colored images. In an alternative embodiment of the invention, the threshold value is determined by calculating the median between upper and lower values of the average pattern vectors within the classes. The lower value can be defined as the largest vector component within the average patterned vectors of solidly colored images. In one embodiment of the invention, the upper value can be defined as the vector component within the class of patterned images, having the least value that is larger than the lower value. The median of the lower and upper value is then defined as the threshold value.

In an alternative embodiment of the invention, the image processing unit 125 determines if a predetermined number of components of an average pattern vector are above a threshold value to determine if an image is patterned or solidly colored. For example, the image processing unit 125 could define a patterned image as image with an image pattern vector having N or more vector components above a threshold value. The threshold value could be determined using a similar method as the ones described previously. In one embodiment, the threshold value is determined as the vector component of the average pattern vectors within the class of solidly colored images having the Nth largest value. Alternatively, the threshold value is defined as the vector component having the largest value. In another embodiment, the upper and lower values of the training set are determined and the median is defined as the threshold value.

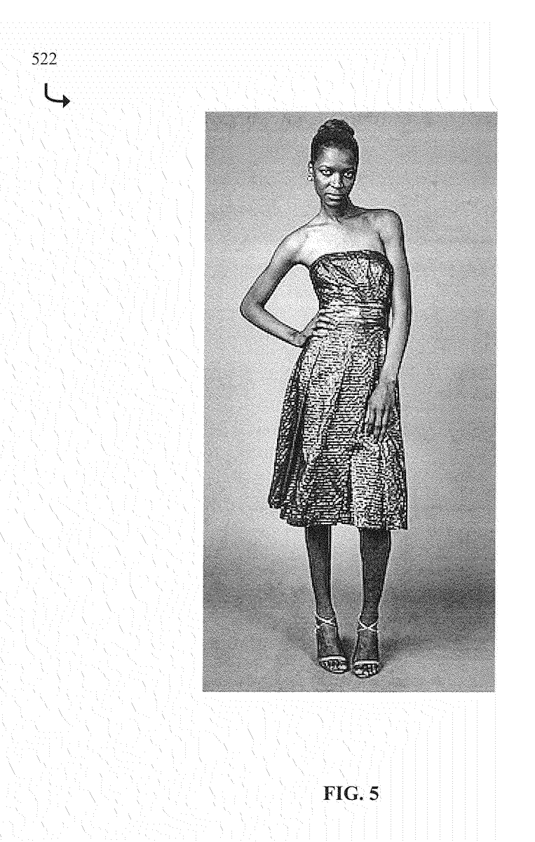

FIG. 4 illustrates a flow chart 400 of a method of segmenting the foreground of an electronic image. An example of an electronic image used is depicted in FIG. 5, where the image includes a background and a foreground comprising a human wearing an apparel item. Alternatively, the foreground may comprise a mannequin wearing an apparel item. At step 410, the image processing unit 125 receives the image. Next, in step 420, the image processing unit 125 identifies the foreground mask and background of the electronic image. The process of distinguishing a foreground mask from a background of an image is illustrated by the flow chart of FIG. 8. After identifying the foreground mask, the image processing unit 125 proceeds to step 430 and scans the foreground mask to detect skin pixels. In order to detect skin pixels, the image processing unit 125 compares the color and pattern of pixels in the foreground mask to predetermined skin colors and patterns. A predetermined skin model may be established by sampling a large set of images of people of different races and mannequins of different colors. In a preferred embodiment, the image processing unit performs a preliminary scan of the top portion of the electronic image to detect skin pixels. In this embodiment, once skin pixels have been detected in the electronic image, the image processing unit 125 learns the skin pixel distribution in order to train a skin classifier to detect skin pixels in the rest of the foreground mask. Next, in step 440, the image processing unit 125 detects residual background pixels in the foreground mask by detecting the pixel color and patterns of the background and comparing these colors and patterns to the pixels of the foreground mask. In a preferred embodiment, the image processing unit 125 detects the pixel color and patterns of the background area closely surrounding the foreground mask. Once these local background pixel colors and patterns have been learned, the image processing unit 125 uses these pixel colors and patterns to train a background classifier and detect residual background pixels in the background mask. In step 450, the image processing unit 125 classifies each pixel of the foreground mask as a skin pixel, an apparel foreground pixel, or background pixel based upon each pixel's quantifiable values including LAB color values, Gabor filter response values, and texture descriptor values.

In another embodiment, the image processing unit 125 also creates a classifier for hair color and texture, whereby the foreground mask pixels are classified into skin pixels, hair pixels, apparel foreground pixels, and background pixels. Alternatively, the image processing unit 125 creates a single classifier to describe skin and hair pixels. In another embodiment, the pixel label classifiers are linear, quadratic, log-linear, probabilistic, or logistic classifiers. Alternatively, the pixel label classifiers are support vector machines. In another embodiment, the pixel label classifiers are neural network classifiers or decision tree classifiers. In another embodiment, equivalent regression methods may be used to identify pixel labels. Alternatively, a combination of classifiers and regression-methods may be employed to distinguish pixel types. In another embodiment, the image processing unit 125 further distinguishes a plurality of apparel items depicted in a single foreground mask by identifying edge points at which the brightness of the pixels in the foreground contains discontinuities. In another embodiment, where there is no human or mannequin model depicted in the image, the foreground mask pixels are classified into apparel foreground pixels and background pixels.

FIG. 5 illustrates an electronic image 522 according to one embodiment. In this embodiment, the electronic image 522 depicts a humanoid figure wearing an apparel item. The humanoid figure is a human model, wherein the entire body of the human model is depicted in conjunction with the apparel image. Moreover, in this embodiment, the apparel image 522 depicts a human model wearing a dress and a pair of shoes. In an alternative embodiment, the humanoid figure may be a portion of a human model, a mannequin depicting an entire human body, a mannequin depicting a portion of a human body, or any other representation of a human body displaying an apparel item. In this embodiment, the electronic image 522 is a depiction of the humanoid figure comprising at least one anatomical structure of the humanoid figure. For example, in one embodiment the electronic image 522 may depict a portion of a human model wearing a dress, wherein the head of the human model is cropped or otherwise not represented in the picture. In another embodiment, the electronic image 522 also depicts a headless mannequin wearing a sweater, wherein the bottom portion of the mannequin has been cropped or otherwise not represented in the picture. An apparel item depicted in an electronic image 522 may include, for example, clothing such as shoes or handbags.

FIG. 6 illustrates a flowchart 600 of a method of extracting spatial and color characteristics of an object depicted in an electronic image. At step 601, the image depicting the object is retrieved by the image processing unit 125. In a preferred embodiment, the image includes a background and a foreground depicting a shoe or a handbag. In step 602, the image processing unit 125 extracts the foreground from the background of the image. This can be done in accordance to the method of FIG. 8. In the preferred embodiment, after the background is subtracted from the foreground of the image, the image depicts a shoe or a handbag.

After the background is subtracted from the foreground of the image, the image processing unit 125 performs step 603 and normalizes the spatial features of the foreground. In a preferred embodiment, the image processing unit 125 performs a principle component analysis (“PCA”) of each pixel of the extracted foreground. In PCA, object image data of a multi-dimensional image space can be converted to a feature space, which uses the principal components of the eigenvectors characterizing the image space. Specifically, the eigenvectors are representative of the variance of changes in spatial position of a pixel group. PCA simply performs an axis rotation, aligning the transformed axis with the directions having the maximum spatial variance. In the preferred embodiment, PCA enables the comparison of images depicting similar objects that are centered along different spatial axis. Particularly, PCA can be viewed as normalizing the axis similar objects.

Once the image processing unit 125 transforms the foreground image into an image aligned along the direction having the most spatial variance, the image processing unit 125 extracts the spatial characteristics of the object depicted on the foreground of the electronic image and the color characteristics. In a preferred embodiment, spatial characteristics of the object are determined using a pyramid histogram of oriented gradients, or PHOG descriptor, of the inner and contour portions of the image. The idea behind the PHOG descriptor is to define the spatial characteristics of an object by the object's local features and the object's spatial layout. For example, an object's local features can be expressed as a simple histogram of oriented gradients, defined as a histogram representative of the angular orientations of the object's edge regions. This may be expressed by calculating a histogram of N bins, where the bins of the histogram are representative of the angular orientation and the weight of each bin corresponding to the number of edge regions grouped within the bin's angular orientation.

An image may be subdivided into increasingly finer image layers, such that each successive image layer is a regional quadtree of the previous one divided by cells. A histogram of the oriented gradients for each cell in the layered pyramid could then be determined. For example, suppose an image pyramid contains three layers. The first layer L=0 would correspond to the image being divided by one cell. The next layer L=1 would be subdivided into 4 cells, and the next level L=2 would be subdivided into 16. A HOG vector could then be taken of each 21 cells. A HOG vector is simply a vector with a length equal to the number of bins N, with each value equal to the weight of the respective bin. Once all of the HOG vectors are determined, a PHOG vector is derived as the concatenation of all of the normalized HOG vectors.

The foreground contour characteristics, the inner foreground spatial characteristics, and the color characteristics of the foreground are then determined by the image processing unit 125 using the PHOG descriptor by steps 604A, 604B, and 604C, respectively. To perform the steps of extracting the contour foreground characteristics 604A and the inner foreground characteristics 604B, the image processing unit groups all of the pixels as either inner pixels or contour pixels. The image processing unit 125 categorizes the contour pixels as all of the pixels located along the farthest spatial boundaries of the transformed foreground image. The image processing unit 125 categorizes all of the other pixels of the transformed foreground image as inner pixels. In the preferred embodiment, once the image processing unit 125 categorizes each pixel of the transformed foreground image as either an inner pixel or a contour pixel, the image processing unit determines a PHOG histogram representation of the spatial orientation of the inner features and a PHOG histogram representation of the contour features of the foreground for a predetermined amount of pyramidal layers.

The number of layers of the image pyramid can be predetermined. In a preferred embodiment, a contour pixel represents an edge region. A HOG histogram of each cell in the image pyramid is calculated by analyzing the pixel gradients of each pixel surrounding a given contour pixel, and determining the angular orientation of the contour pixel for each cell in the image's cell based pyramid. In a preferred embodiment, each edge region corresponds to a pixel. For example, the total of the intensity gradients of pixels located within a 3×3 pixel matrix, centered at the analyzed contour pixel, may be analyzed to determine the angular orientation of the centered contour pixel. The gradients of the outlying 8 pixels are analyzed, and the analyzed contour pixel is assigned a particular angular orientation. Alternatively, a 5×5 or larger pixel matrix centered at the contour pixel may be used to determine the angular orientation. In the preferred embodiment, each histogram bin corresponds to an angular orientation of 0-360 degrees and the weight of each bin corresponds to the number of pixels assigned to each bin. Alternatively, the histogram bins can be representative of angular orientation between 0-180 degrees. The number of bins spanning the angular orientation limits is arbitrarily chosen. For example, in determining the angular orientation of a 2 dimensional image contour, for 0 to 360 degrees, each histogram bin may be separated by 60 degrees, such that total the number of bins is 6. A y-axis value, or weight, to each bin would correspond to the number of contour pixels having an angular oriented gradient closest to the assigned angular orientation of the respective bin. Once all of the histograms of each cell of the image pyramid are determined, the PHOG descriptor is determined as a concatenation of the HOG histogram vectors.

The same process used to determine a histogram representative of the oriented gradient of each contour pixel is also performed on each inner pixel in step 604B. This histogram is representative of the spatial characteristics of the inner foreground shape. In this step, the image processing unit 125 defines the inner pixels as the edge points. Alternatively, each histogram is normalized such that they are representative of a probability distribution function. To do this, the histogram is normalized to have a sum over all angular orientations equal to one.

The image processing unit 125 also determines the color characteristics of the foreground image in step 604C. The image processing unit 125 determines the color characteristics of the foreground object by using each foreground pixel to determine a histogram representative of the foreground color in accordance to the method of FIG. 10. After the image processing unit 125 determines data representative of the color, inner, and contour characteristics of the foreground, the image processing unit 125 saves this data in the server 120 in step 605A. The data is also saved on the database unit 115A of the memory unit 115 at step 605B. Alternatively, the data is stored in the database 115A, and the database unit 115A is not a part of the memory unit 115. For example, the image processing unit 125 could be in direct communication with the database unit 115A through a data cable such as a USB, USB 2.0, mini USB, FireWire 400, FireWire 800, or other data cable connection. Alternatively, the image processing unit 125 may be in communication with the memory unit 115 by a variety of wireless protocols, such as a WIFI communication link.

FIG. 7 illustrates a method 700 of comparing the visual characteristics of an electronic image with electronic images represented by data stored in a database, storing the electronic image in the database, and then reorienting the database to account for the new image. In a preferred embodiment, the visual characteristics of an electronic image are compared to visual characteristics of each image stored in the database 115A, wherein the database 115A contains the visual characteristics of a plurality of electronic images. At step 701, the image processing unit 125 retrieves image data, including visual characteristics, of an image that is stored in the database 115A. In a preferred embodiment, this data also includes text based data representative of the image, and other data obtained by the data retrieval unit 140. The electronic image that is compared to images represented in the database 115A is referred to as the query image. In a preferred embodiment, the image characteristics are represented by histograms determined in accordance to the method of FIG. 6. The image processing unit 125 then retrieves image data representative of an image stored in the database 115A in step 702. In a preferred embodiment of the invention, this data also includes any text-based data stored as metadata in the database 115A, such as data representative of the visual characteristics, any text-based data, and image category. This respective image is referred to as the target image in the database 115A storing a plurality of target images.

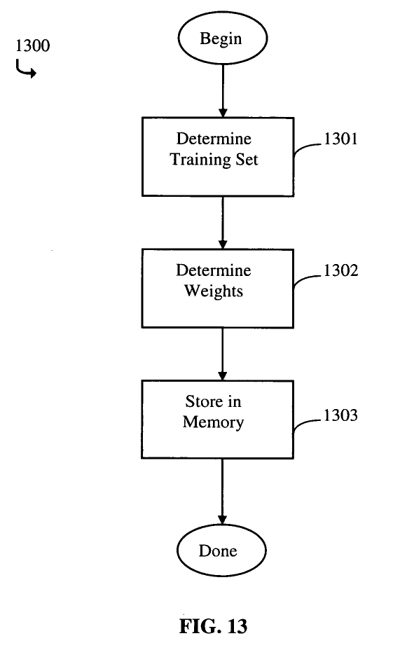

The image processing unit 125 then proceeds to step 703 and determines whether the query image and the target image are of the same category. The image processing unit 125 performs this by comparing data representative of the query image category with data representative of the target image category stored as metadata in database 115A. When the image processing unit 125 determines that data representative of the category of the target image and the query image are different, such that the query image and target image depict different objects, the image processing unit 125 determines the color difference of the query image and the target image in step 704A. The image processing unit 125 does this in accordance to the method of FIG. 10. When the image processing unit 125 determines that the data representative of the category of the query image and the target image are the same, the image processing unit 125 determines the weighted color, weighted inner shape, and weighted outer shape difference of the query image and the target image in step 704B. The image processing unit 125 determines the weighted values in accordance to the method of FIG. 13. The image processing unit 125 then stores the value representative of the difference in the database 115A in step 705. The data is stored as metadata representative of the difference between the query image and the target image used.

The image processing unit 125 then determines if the query image has been compared to all target images represented in the database 115A in step 706. When the image processing unit 125 determines that all target images stored in the database 115A have not been compared to the query image, the image processing unit 125 returns to step 702 and retrieves data representative of a target image that has not been compared to the query image. In a preferred embodiment, the data representative of target images are stored in the database unit 115A with metadata associated with a target image numerical value. The image processing unit 125 runs a counter program that marks each numerical value of a target image when the respective target image is compared to the query image. For example, 150 target images could be represented by data stored in the database 115A. Each of the target images is associated with a numerical value, 1-150, and no target image is associated with the same numerical value. The image processing unit 125 could compare the query image to target images in ascending order, such that the image processing unit 125 would compare the query image to the target image associated with numerical value 1, then the target image associated with the numerical value 2, and so on. Once the processing unit 125 compares the query image to the target image associated with the numerical value of 150, the processing unit 125 would stop looping back to step 702. Alternatively, the image processing unit could retrieve the number of target images, N, represented in the database 115A and mark how many times the image processing loops back to step 702. Once the image processing unit 125 marks that the loop to step 702 has been performed N−1 times, the image processing unit 125 would then stop looping to step 702.

Once the image processing unit 125 has compared the query image to all of the target images, the image processing unit 125 goes to step 707 and ranks the metadata representative of the differences between the query image and each target image stored in the database 115A. After the image processing unit 125 has ranked the metadata, the image processing unit 125 determines which target images are image matches with the query image in step 708 and the image processing unit proceeds to step 709 and stores the matches in the database 115A. The image processing unit 125 determines matches by grouping the target images having the least difference with the query image. The number of matches in the grouping may correspond to a predetermined value stored in the processing memory unit 130 or another memory storage unit in communication with the image processing unit 125. For example, the size of the grouping may be defined as the 50 target images having the least difference value with the query image. In this case, these 50 target images are stored as match metadata associated with the query image in the database 115A. In one preferred embodiment, once the query image has been assigned 50 target image matches in the database 115A, matches associated with all of the target images are also altered. In one embodiment of the invention, the image processing unit 125 recalculates the matching images of each target image stored in the database, such that the images that are matches with the target image as metadata are the predetermined number of images having the least differences with the target image when the query image has been applied to the target images and represented in the database as an additional target image. Alternatively, the image processing unit 125 defines the set of matches in terms of a fraction of all of the target images stored in the database. For example, the image processing unit 125 could assign matches to a query image by determining the top 25% of target images having the least differences with the query image. In the present example, if 100 target images are stored in the database 115A, the image processing unit 125 would assign the 25 target images having the least difference with the query image as match metadata and store this in the database 115A.

FIG. 8 illustrates a flowchart of a method 800 of determining the background and the foreground of an electronic image and extracting the foreground from the image. In one embodiment, the electronic image includes a background and a foreground depicting an object such as an apparel item. Alternatively, the electronic image includes a background and a foreground depicting a human body or mannequin wearing an apparel item. At step 810, the image processing unit 125 runs an edge detection algorithm to identify edge points at which the brightness of the electronic image contains discontinuities. Common edge detection algorithms that may be used include Sobel or Canny operators, for example. Next, at step 820, the image processing unit 125 identifies the perimeter of the foreground mask by performing a raster scan of the electronic image. The pixels located within the area marked by the edge points are identified as belonging to the foreground mask, while pixels located outside the edge points are identified as background pixels. Once the image processing unit 125 determines the foreground and background of the electronic image, the image processing unit proceeds to step 830 and extracts the foreground from the background, such that all that remains of the image is the foreground.

When the foreground of the electronic image depicts a human body the image processing unit 125 may run a person detector algorithm on the electronic image before performing the edge detection of step 810. Person detector algorithms that may be used include algorithm templates for detecting portions of a human body. Portions of a body that may be detected by a person detector algorithm include for example, a whole body, a face, a combination of a face and a torso, a combination of a face, torso, and thighs, a combination of a face, torso, thighs, and legs, a combination of a torso, thighs, and legs, or a combination of thighs and legs. In another embodiment, a person detector algorithm may be further used to determine the type of apparel a person is wearing. In another embodiment, a person detector algorithm may be used to extract template specific features. For example, if only a face and torso combination are detected by a person detector, the image processing unit 125 may actively search the apparel image for apparel items corresponding to a face and torso combination, including for example, sunglasses, eyeglasses, necklaces, shirts, blouses, sweaters, jackets, scarves, vests, tops, bras, hats, earrings, rings, hair pieces, etc. Examples of person detector algorithms that may be used include histogram of oriented gradients (“HOG”) descriptor algorithms. In this embodiment, the image processing unit 125 narrows its focus on a particular area of an electronic image in order to augment the process of identifying the foreground mask of the electronic image. This embodiment may be particularly useful when the background of the electronic image contains objects such as buildings, cars, or trees as may be the case if the apparel item of the electronic image is displayed in an urban setting. In another embodiment, the image processing unit 125 may perform a horizontal raster scan, a vertical raster scan, a diagonal raster scan, or a combination of multidirectional raster scans to identify the perimeter of the foreground mask of the electronic image. In another embodiment, edge detectors trained to detect contours of humanoid figures may also be used in place of or in addition to the use of a person detector algorithm. Alternatively, the output of region-segmentation algorithms may also be used in place of or in addition to the use of a person detector algorithm. Examples of region-segmentation algorithms that may be used include k-means based color clustering segmentation, watershed segmentation, graph based segmentation, and mean-shift based segmentation.

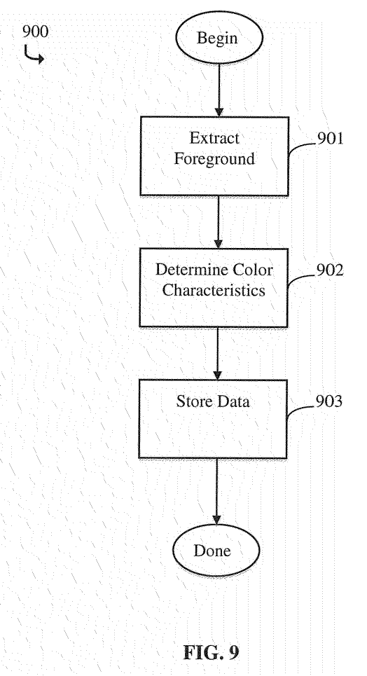

FIG. 9 illustrates a method 900 of determining the color characteristics of an object depicted on an electronic image. In one embodiment, the image includes a background and a foreground depicting the object. In the preferred embodiment of the invention, the object is an apparel item, such as a handbag, shoes, or a dress. Alternatively, the object may comprise an anatomical structure wearing an apparel item. The anatomical structure may be a human body, human limb, an entire mannequin, or a limb of a mannequin. In step 901, the image processing unit 125 extracts the foreground from the background of the image. This step is performed in accordance to the method of FIG. 8. Once the foreground is extracted from the background, the image processing unit 125 determines the color characteristics of the foreground in step 902. In a preferred embodiment of the invention, the color characteristics are represented as a histogram with weighted bins. In a preferred embodiment, an x-axis indicates the LAB color value and a y-axis indicates the number of pixels. Thus, the bins of the histogram are representative of an LAB color value and the y-axis value of each bin, or weight, indicates the number of pixels associated with the bin's LAB value. Specifically, the image processing unit 125 constructs the histogram by determining the number of bins to be used in the histogram. Preferably, the number of bins is large, such that a spectrum of LAB values are analyzed. The number of bins used by the image processing unit 125 is preferably stored in the processor memory unit 130. Alternatively, the image processing unit 125 determines a spectrum based on RGB or HSV color values.

Once the image processing unit 125 retrieves the bin number from the processor memory unit 130, the image processing unit 125 preferably assigns each bin to a LAB value such that all bins are equidistant along LAB space and the broadest LAB color spectrums are represented. The image processing unit then determines the LAB value of each pixel of the foreground of the electronic image and assigns each pixel to the bin located in LAB space that is closest to the pixel's LAB value. Once the histogram representative of the color characteristics of the image's foreground is calculated, the image processing unit 125 stores data representative of the histogram in the database 115A as metadata associated with the tested image in step 903.

FIG. 10 illustrates a method 1000 of comparing the color characteristics of an object depicted by an electronic image with another object depicted by an electronic image. In one embodiment, the image includes a background and foreground comprising the object. In another embodiment, the object is an apparel item, such as a handbag, shoes, or a dress. The object can also include an anatomical structure wearing an apparel item. The anatomical structure may be a human body, human limb, an entire mannequin, or a limb of a mannequin. At step 1001, the image processing unit 125 determines color histograms representative of the object color in accordance to the method of FIG. 9. At step 1002, the image processing unit 125 determines the difference between the two histograms. Alternatively, the image processing unit 125 normalizes the histograms to have a sum equal to one and determines the difference between these two functions. This is done by determining a continuous function that correlates the most with the histogram having an integral equal to 1 over all color space.

Once the histograms representative of the color characteristics of the two objects are determined, the color difference between the two objects is determined by the image processing unit 125. This can be done by calculating the earth mover's distance or EMD between the two histograms. Alternatively, the image processing unit 125 determines the earth mover's distance of two continuous probability distribution functions representative of the two histograms. In another embodiment, the image processing unit 125 computes a different calculation representative of the difference of histograms, such as the squared Euclidean distance between their representations, calculating the Manhattan distance between their representations, calculating the Chi-squared distance between their representations, or calculating the distance based on the histogram intersection. Once the difference is determined, the value is stored as metadata associated with the images depicting the objects in the database 115A.

FIG. 11 illustrates a flow chart of a method 1100 of developing and using pattern filters. In step 1101, the image processing unit 125 receives an electronic image including a patterned portion of the image. Next, in step 1102 the image processing unit 125 identifies an area of the patterned portion of the image. In one embodiment, the electronic image comprises a patterned image such that the image itself is entirely patterned. Alternatively, the electronic image comprises a background and a patterned object comprising the image foreground. The image processing unit 125 subtracts the background from the foreground in accordance to the method of FIG. 8 in order to retrieve the patterned portion of the image. Alternatively, the electronic image includes a background and a foreground wherein the foreground depicts a person, limb, mannequin, or limb of a mannequin wearing patterned apparel.

After extracting a patterned portion of the electronic image, the image processing unit 125 proceeds to step 1103 and samples the patterned portion of the electronic image by copying an area of the patterned portion of the electronic image. In the present embodiment, this may be accomplished by identifying a set of sample points in the patterned foreground. The location of these sample points may be randomly selected or selected through strategic determinations, including, for example, selecting points at edges detected within the patterned portion of the electronic image. In this embodiment, an area of pixel intensities around each of the sample points may be used to represent a sampled patterned.

Next, in step 1104, each sample point is converted to a vector or one-dimensional array. For example, in one embodiment, the area of pixel intensities that are identified as the sampled pattern is a square with both a pixel width and pixel height of D pixels. In this embodiment, the area of the sampled pattern comprises D×D pixels (or written alternatively as D² pixels). The sampled pattern is then converted to a 1×D² one-dimensional vector (or a one dimensional array). For example, in one embodiment, wherein the dimensions of the sampled pattern is three pixels wide by three pixels tall, a vector representation of the sampled pattern may be organized as a 1×9 vector (or a one dimensional array comprising nine pixel intensity values). The parameters of the vector may be organized as the pixel intensity values of the three pixels positioned along a first line of the sampled pattern, concatenated by the pixel intensity values of the three pixels positioned along the middle line of the sampled pattern, further concatenated by the pixel intensity values of the three pixels positioned along the third line of the sampled pattern. Thus, when the dimensions of the sampled pattern is 3 pixels wide by 3 pixels tall (3×3) and encompasses an area represented by 9 pixels, the vector representation of the sampled pattern is a one dimensional vector of 9 pixel intensity values. In an alternative embodiment, the organization of the vector representing the sampled pattern may be arranged in any other manner that represents the sampled pattern. For example, a vector for representing a sampled pattern of a width of three pixels and a length of three pixels may be organized as the pixel intensity values of the three pixels positioned along a bottom line of the sampled pattern concatenated by the pixel intensity values of the three pixels positioned along the middle line of the sampled pattern, further concatenated by the pixel intensity values of the three pixels positioned along the top line of the sampled pattern.

Next, in step 1105, the image processing unit 125 records a plurality of sampled patterns in the processing memory unit 130. In step 1106, the image processing unit 125 retrieves the sampled pattern from the processor memory unit 130. Alternatively, the image processing unit 125 retrieves the sampled pattern from the data retrieval unit 140 from the server 130. In a different embodiment, the image processing unit 125 retrieves the sampled pattern from another memory unit in communication with the image processing unit 125. Next, in step 1107, the image processing unit 125 performs a vector quantization on all of the sampled patterns stored in the processor memory unit 130. In a preferred embodiment, the function of vector quantization in step 1107 is performed by processing all of the sampled patterns stored in the processor memory unit 130 through a k-means clustering algorithm to determine the centroid points of a set of k clusters, wherein k represents a variable. After this, the image processing unit 125 proceeds to step 1108 and identifies the coordinates of the centroid points as the representation of a plurality of pattern filters. Specifically, the k centroids represent pattern filter vectors.

In a preferred embodiment, following the construction of the pattern filters in accordance to the method of FIG. 11, depictions in the foreground of an image may be extracted and characterized using the pattern filters stored in the processor memory unit 130. Alternatively, the entire image may be categorized using the pattern filters stored in the processor memory unit 130. The pattern features of the image is expressed as an average pattern vector, with each vector component representative of the average response of the image to a pattern filter. As described previously, the intensity values of points surrounding a given target point are vectorized. This vector is representative of a target point's pattern and texture characteristics. After the vector is determined, the convolution of the vector with each pattern filter vector is calculated. For example, let pᵢ be a point located in an image containing a number of points, and is a vector representative of the intensity values of points surrounding point pᵢ. Let \vec{f}ⱼ be a pattern filter vector in a set of F pattern filter vectors. The convolution of \vec{p}ᵢ and each patter filter vector \vec{f}ⱼ within set F=[\vec{f}₁ \vec{f}₂ . . . \vec{f}ₙ₋₁ \vec{f}ₙ] is calculated. This may be expressed in vector format as a vector \vec{v}ᵢ=[\vec{p}ᵢ*\vec{f}₁ \vec{p}ᵢ*\vec{f}₂ . . . \vec{p}ᵢ*\vec{f}ₙ₋₁ \vec{p}ᵢ*\vec{f}ₙ]. This process is performed for each point of the image. The average pattern vector is constructed by taking the average convolution of each point of the image to each pattern filter vector. The average pattern vector may be expressed as \vec{v}ₐᵥₑ=[(\vec{p}*\vec{f}₁)ₐᵥₑ (\vec{p}*\vec{f}₂)ₐᵥₑ . . . (\vec{p}*\vec{f}ₙ₋₁)ₐᵥₑ (\vec{p}*\vec{f}ₙ)ₐᵥₑ]. This vector is used to define the pattern characteristics of an image. Once an average pattern vector is calculated for each of two images, the pattern difference between the two images is taken as the L1 norm, which is the sum of the absolute differences between the two vectors.

In an alternative embodiment, the vector quantization of step 1107 may be performed through other algorithm methodologies including, for example, mean-shift clustering, graph-based clustering, expectation-maximization clustering methods (Gaussian mixture models), hierarchical clustering, spectral clustering, fuzzy k-means clustering, randomized trees clustering, k-d tree based methods, random projections based clustering, and neural-network based methods. Correspondingly, for these alternative embodiments, the parameters for a pattern filter may be represented by methodologies including, for example, a centroid point representing a cluster group, a distributed representation of a cluster group, a cluster border, and a support vector based representation of a cluster group, wherein this representation is used to vector quantize novel pattern points.

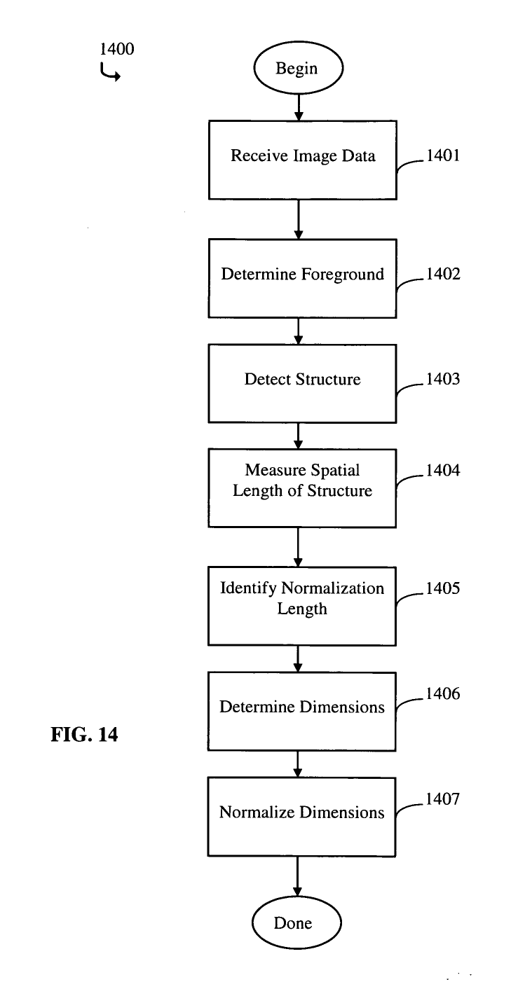

In a preferred embodiment, the images of the sampled patterns comprised in the processor memory unit 130 are all equal in scale. In another preferred embodiment, before the image processing unit 125 samples a patterned area of an electronic image in step 1103, the image processing unit 125 determines a normalization length of the electronic image. The process of determining a normalization length of an image is illustrated in the flow chart of FIG. 14. In this embodiment, the image processing unit 125 normalizes the dimensions of the sampled pattern area so that the image captured in the object pattern is set to the same scale as the images of the apparel patterns stored in the processor memory unit 130. In another embodiment, the spatial pixel dimensions of the apparel patterns contained in the sampled pattern set 204 are all equal. In this embodiment, the spatial pixel dimensions of the sampled pattern 202 would also be equal to the spatial pixel dimensions of the sample patterns of the sampled pattern set 204. In another embodiment, the image processing unit 125 extracts a plurality of apparel patterns from the electronic image. In another embodiment, the image processing unit 125 further samples a predetermined proportion of the total area depicting the apparel item. In another embodiment, the image processing unit 125 further performs a random sampling of the total area depicting an apparel item. Alternatively, a human operator selectively chooses which areas of an apparel item depicted on an electronic image to sample. In another preferred embodiment, the image processing unit 125 repeats steps 1101 through 1105 using different images in order to populate the pattern database 203 with sampled patterns 202.

In another preferred embodiment, the pattern filter 205 is used to detect the presence or absence of a pattern in an image of an apparel item. In another preferred embodiment, a plurality of pattern filters 205 is used to create a distribution representing the presence or absence of patterns in an image of an apparel item. In a preferred embodiment, apparel items can be compared on the basis of various apparel characteristics including for example, apparel colors, apparel patterns, and apparel style elements. Apparel style elements may further comprise apparel features including, for example, sleeve length, neckline, dress length, shoe size, heel size, toe size, toe shape, frame shape of sunglasses and eyeglasses, lens shape for sunglasses and eyeglasses, etc. In a preferred embodiment, color comparison between apparel items is performed by identifying apparel foreground pixels in each of two apparel images and processing these apparel foreground pixels independently through vector quantization processes. Vector quantization processes that may be used include for example, k-means, k-d trees, k-medians, spectral clustering, graph based clustering, meanshift based clustering, expectation maximization based clustering, and random projections based clustering. In another embodiment, simple histograms in the color LAB color space may be used. Alternatively, simple histograms in the color RGB or HSV color space may be used.

FIG. 12 illustrates a flowchart of a method 1200 of extracting pattern and color characteristics of an object depicted in an electronic image. In step 1201 the image processing unit retrieves data representative of an image. At 1202, the image processing unit 125 extracts the foreground from the background of the image. This is done in accordance to the method of FIG. 8. Alternatively, the image processing unit 125 extracts any skin pixels or mannequin pixels included in the foreground of the image. This is done in accordance to the method of FIG. 4. In a preferred embodiment, after the background is subtracted from the foreground of the image, the image depicts a dress. Alternatively, the image depicts a shoe or a handbag. Once the image processing unit 125 determines the foreground, the image processing unit 125 determines the color characteristics and the pattern characteristics of the foreground or segmented foreground. The image processing unit 125 determines the color characteristics in accordance to the method of FIG. 10, where the image processing unit determines a histogram representative of the foreground in step 1203A. The image processing unit 125 also determines a histogram representative of the pattern characteristics of the image in step 1203B. This histogram is determined in accordance to the method of FIG. 11. Once the image processing unit 125 determines the pattern and the color characteristics, the image processing unit 125 goes to step 1204A and saves the data representative of the pattern and color characteristics in the server 120. Also, the image processing unit 125 saves this data to the memory unit 115 in step 1204B. Preferably, the data is stored in the database 115A of the memory unit 115 as metadata representative of the image. Alternatively, the data is stored in the processor memory unit 130, or a memory unit in bidirectional communication with the image processing unit 125.

FIG. 13 illustrates a flowchart of a method 1300 of determining the weighted differences between the visual characteristics of objects depicted on an electronic image. Not all visual characteristics are equally important in determining the visual differences between one image and another. For example, color differences between two objects may be more important than pattern differences between the objects. Therefore, a process of weighting different categories of visual differences may be needed when comparing multiple visual differences. For example, in the method of FIG. 7, the color, inner spatial, and contour spatial characteristics of two images may need to be compared. In order to determine an accurate aggregate difference between the two images, weights of the three visual differences can be determined.

In a preferred embodiment of the present invention, the weights are determined using a discriminative weight learning method. In discriminative weight learning, the aggregate visual difference between images A and B can be expressed as

$$d ( A , B ) = {\sum }_{i = 1}^{C} {w}_{i} {d}_{i}^{A , B} ,$$

where C represents the number of visual aspects, i represents a single visual aspect, wᵢ, represents the weight of visual aspect i, dᵢ^{A,B} represents the difference between A and B of visual aspect i, and d(A,B) represents the aggregate difference between the images. In order to learn the weight values, a training set of images is used, wherein it has been predetermined which classes the images in the set are labeled as belonging to. Using these class determinations on the images, it is learned how each of these classes/labels vary in feature space. The values of the weights are then found such that the images are grouped according to their correct predetermined classification.

In step 1301, S images belonging to C classes were chosen and used as the training set. For every image, iεS different classes, the class of image i can be determined by using the labeling function m (i)ε{1, . . . , C}. In a preferred embodiment, the classes are solidly colored or patterned in order to determine the weighted pattern and color difference of step 1504 in the flowchart of FIG. 15. In another preferred embodiment, the classes are based on the inner shape, contour shape, and color of an image to determine the weighted spatial and color difference in step 704B in the flowchart of FIG. 7. For every pair of images in the set S, the distance vector of the pair of training images in class space has already been calculated. The EMD, or earth mover's distance, is used to determine the difference between these distributions, which is representative of the differences between the distributions. In other embodiments, the difference can be calculated using other methods including, for example, the squared Euclidean distance between their representations, calculating the Manhattan distance between their representations, calculating the Chi-squared distance between their representations, or calculating the distance based on the histogram intersection. Expressed differently than the equation above, the weighted difference between two images is d_{\vec{w}}(Iᵢ,Iᵢ)=\vec{w}^{T}(\vec{d}(i,j)). Knowing that training images grouped within a class have an aggregate difference that is less than images grouped into another class, the following relationships must be true:

∀i,j,k:m(i)=m(j); i≠j; m(i)≠m(k)

Letting M be the total number of triplet distances Δ\vec{d}(i,j,k), then:

d_{\vec{w}}(Iᵢ,Iⱼ)≦d_{\vec{w}}(Iᵢ,Iₖ);

[symbol]

\vec{w}^{T}(\vec{d}(i,k)−\vec{d}(i,j))≧0; and

∴\vec{w}^{T}(Δ\vec{d}(i,j,k))≧0.

The values of the weight can then be learned using the maximum margin formulation:

$${min}_{\vec{w}} [ \frac{λ}{2} {\vec{w}}^{T} \vec{w} + \frac{1}{M} {\sum }_{( i , j , k )} max \{ 0 , 1 - {\vec{w}}^{T} ( Δ \vec{d} ( i , j , k ) ) \} ] .$$

In a preferred embodiment of the invention, this equation is solved using the sub-gradient decent method, wherein λ is a constant that combines the regularization term to the hinge-loss term in the cost function. For example, λ can be set to be a constant of the same order or magnitude as the hinge-loss term. With an initial guess of \vec{w}₀, the following algorithm can be used in K iterations to solve it and determine weights in step 1302:

Algorithm 1: SubGradient Descent (SGD)

| | Input: \vec{w}₀ ∈ [symbol] ^{D}, K | | |
|---|---|---|---|
| | Output: \vec{w}_{K} | | |
| 1 | begin | | |
| 2 | \| | Initialization: t ← 0 | |
| 3 | \| | for t ≦ K do | |
| 4 5 | \| \| | \| \| | $\begin{matrix}{A}_{t}^{+} = \{ ( i , j , k ) : {\vec{w}}^{T} ( Δ \vec{d} ( i , j , k ) ) < 1 \} \\ {η}_{t} = \frac{1}{λ t}\end{matrix}$ |
| 6 | \| | \| | ${\vec{w}}_{t + \frac{1}{2}} = ( 1 - {η}_{t} ) {\vec{w}}_{t} + \frac{{η}_{t}}{M} {\sum }_{{A}_{t}^{+}} Δ \vec{d} ( i , j , k )$ |
| 7 | \| | \| | ${\vec{w}}_{t + 1} = min \{ 1 , \frac{1 / \sqrt{λ}}{\sqrt{{\vec{w}}_{t + \frac{1}{2}}^{T} {\vec{w}}_{t + \frac{1}{2}}}} \} {\vec{w}}_{t + \frac{1}{2}}$ |
| 8 | \| | \| | t ← t + 1 |

| | | |
|---|---|---|
| 9 | \| | end |

| | |
|---|---|
| 10 | end |

Once the weights are determined, the weights are stored in the processor memory unit 130 in step 1303. This is done by sending the values representative of the weights to the processor memory unit 125 from the data retrieval unit 140. The image processing unit 125 then relays the data to the processor memory unit 130. Alternatively, the data is relayed and stored in the memory unit 115. In a preferred embodiment; the data retrieval unit 140 comprises a laptop computer in communication with the image processing unit 125. Alternatively, the data retrieval unit 125 comprises a web crawler that retrieves the weighting values from a website through a server.

FIG. 14 illustrates a method 1400 of normalizing a structural dimension of an object depicted on an electronic image. In a preferred embodiment, the object is an apparel item. At step 1401, data representative of the image is received by the image processing unit 125. After the data is received, the image processing unit 125 may proceed to step 1402 and distinguish the foreground from the background. The process of distinguishing a foreground mask from a background of an image is illustrated by the flow chart of FIG. 8.

Once the perimeter of the foreground mask of the electronic image has been identified, the image processing unit 125 may detect a structure in the electronic image by searching the foreground mask for known structural shapes in step 1403. In a preferred embodiment of the invention, the image processing unit 125 searches for anatomical shapes in the foreground mask. The image processing unit 125 may detect anatomical structure shapes by searching the foreground mask area for lines that match a predetermined template that corresponds with a predetermined anatomical structure shape. For example, the image processing unit 125 may detect shoulders by searching the upper half of the foreground mask for lines that match a shoulder template consisting of a corner-like structure with a major change in orientation. In a preferred embodiment, this template is deformable so that it accounts for different shoulder poses.

After an anatomical structure has been detected, the image processing unit 125 may proceed to step 1404 and measure a spatial length of the structure. The spatial length of the structure may be determined by calculating the distance between two points representative of a predetermined structure. For example, the spatial length of an anatomical structure may be calculated by measuring the distance between two points of the structure that are separated by the greatest distance. This distance may be measured by counting the pixel length of a line connecting these two points. Next, the image processing unit 125 may proceed to step 1405 and identify a normalization length that is equal to or proportional to the length of the anatomical structure. After determining a normalization length, the image processing unit 125 may proceed to step 1406 and determine the dimension of the apparel item included in the foreground.

In step 1406, the image processing unit 125 determines at least one apparel dimension by measuring the spatial length, width, or area of any part of the apparel item depicted in the image. Apparel lengths that may be measured by the image processing unit 125 include a measurement of the entire length of the apparel item or a measurement of a portion of the apparel item such as a sleeve length. The computer set may also perform a series of widthwise measurements to determine a width profile. The image processing unit 125 may further determine the location of a waistline by identifying the location of the apparel item having the smallest width. Once the location of a waistline has been determined, the image processing unit may further determine a skirt length, wherein a skirt length is calculated as a distance from a point on the waistline to a point on the bottom edge of an apparel item such as a skirt or a dress. The image processing unit 125 may also calculate the area of an apparel item by counting the number of pixels representing a region of the apparel item.

Next, the image processing unit 125 may proceed to step 1407 and normalize the apparel dimensions determined in step 1406 by expressing the apparel dimensions as multiples of the normalization length determined in step 1405. For example, if the normalization length determined in step 1405 was set to 100 pixels and the sleeve length of an apparel item is 30 pixels, then the normalized length of the apparel item may be expressed as 0.3 normalization lengths. In another example, if in step 1404 the distance between a pair of shoulders was determined to be 100 pixels, and in step 1405 the normalization length was set to one shoulder length (i.e. 100 pixels), and the length of a dress depicted in the image is measured to be 250 pixels, the normalized length of the dress would be 2.5 normalization lengths (i.e. 2.5 shoulder lengths). In yet another example, if in steps 240 and 250 a shoulder length and normalization length are both determined to be 100 pixels, and the area of a dress depicted in the image is calculated to be 1,000 pixels by summing all pixels depicting the area of the dress, then the normalized area of the dress would be expressed as 1 square normalization length (or alternatively square shoulder length).

In a preferred embodiment, the anatomical structure detected in step 1403 is a pair of shoulders. In another preferred embodiment, the anatomical structure detected in step 1403 may be a waist. For example, once a waist has been detected in the apparel image, the image processing unit 125 may measure the spatial length of the waist by counting the pixels along the waistline, and in step 1407 express an apparel measurement as a multiple of the determined waist length. Alternatively, the anatomical structure detected in step 1403 and measured in step 1404 is a head, a torso, a neck, a waist, an arm, a leg, a hand, a foot, or any anatomical structure that is proportional to a human body. Alternatively, the anatomical structure detected in step 1403 comprises any combination of a head, a torso, a neck, a waist, an arm, a leg, a hand, a foot, or any anatomical structure that is proportional to a human body. In another embodiment, the image processing unit 125 measures a part of an anatomical structure detected in step 1403. For example, in one embodiment the image processing unit 125 in step 1403 detects a torso and arm combination, and in step 1404 the image processing unit 125 measures the distance of the arm from the armpit to the elbow.

In another embodiment, the spatial length of the anatomical structure may be determined by identifying points within the outer bounds of the anatomical structure. For example, in one embodiment the length of a pair of shoulders is measured between two prominent shoulder points. Alternatively, the measurement of the length of the anatomical structure may be calculated by measuring the distance between two points lying in any direction. For example, the length of a head may be measured from top to bottom or from side to side. In a preferred embodiment, the normalization length is equal to the length of the anatomical structure as determined in step 1404. Alternatively, the normalization length may be set to a length proportional to the determined length of an anatomical structure. For example if a shoulder length is determined in step 1404 to be 100 pixels long, the normalization length may be set to four shoulder lengths or 400 pixels. In this embodiment, setting the normalization length to four shoulder lengths creates a normalization length that approximates a humanoid figure's body height. Alternatively, other known statistical proportions of the body may be used to calculate approximate body lengths or body portion lengths or other appropriate normalization lengths. Alternatively, a normalization length may be set to an arbitrary proportional length of the anatomical structure length determined in step 1404.

In an alternative embodiment, the image processing unit 125 may normalize the dimensions of the image before measuring apparel dimensions. For example, if in step 1404 the distance between a set of shoulders identified in the image was determined to be 100 pixels and a predetermined standard measurement for normalized shoulder length has been set at 50 pixels, then the entire image may be resized so that the pixel length of the shoulders in the resized image equals 50 pixels. For example, if the image processing unit 125 contains a set of normalized apparel images, wherein each image of the set comprises an image depicting shoulder pairs measuring 50 pixel lengths, or otherwise similarly scaled images, the image processing unit 125 may resize the image to conform to the scale of the images contained in the set of normalized apparel images. Alternatively, if the shoulder length determined in the image is 100 pixel lengths, and a predetermined standard scale shoulder length is set at 50 pixel lengths, then the ratio of a “standard scale shoulder length” to an “image shoulder length” is 50:100 (or 1:2), and the image processing unit 125 may set the normalization length to 0.5. In this embodiment, a direct pixel measurement of an apparel dimension may be normalized and set to the standard scale by multiplying the direct pixel measurement by the normalization length of 0.5. For example, if a sleeve length in image is measured to be 50 pixels long, the normalized sleeve length would be 25 pixels (50*0.5).

In a preferred embodiment, the image processing unit 125 may determine an apparel dimension by calculating any length measurements of the apparel item. These include lengthwise measurements, widthwise measurements, diagonal measurements, and measurements tracing the outline of the apparel item. For example, in one embodiment, an apparel dimension may include measurements of a neckline, a pant length, an inseam, a waistline, a shoulder line, an arm length, a sleeve length, a dress length, a skirt length, or a strap length. In another embodiment, the image processing unit 125 performs a series of widthwise measurements of the apparel item to determine a width profile. Similarly in another embodiment, the image processing unit 125 performs a series of lengthwise measurements of the apparel item to determine a length profile. In one embodiment, the image processing unit 125 classifies the apparel item by comparing the width profile of the apparel item with a predefined width profile style. Similarly, in another embodiment the image processing unit 125 classifies the apparel item by comparing the length profile of the apparel item with a predefined length profile style. In another embodiment, the image processing unit 125 determines the waistline position of the apparel item by identifying the area of the dress with the smallest widthwise measurement. In another embodiment, the image processing unit 125 expresses the waistline position of the apparel item as a vertical position on the apparel item. In yet another embodiment, the image processing unit 125 further classifies the apparel item by comparing the waistline position of the apparel item with a predefined waistline position style. In another embodiment, the apparel dimension is determined by measuring the distance from a reference point to a point on the apparel item. For example, in one embodiment the image processing unit 125 measures a skirt length by calculating the spatial distance from a waistline position to a point on the bottom edge of a skirt or dress. In another embodiment, the image processing unit 125 measures the distance from the top of the humanoid figure's shoulders to the bottom point of a neckline. In another embodiment, the image processing unit 125 measures the distance from a vertical position representing the bottom of a humanoid figure's foot to a vertical position representing the bottom edge of a skirt or dress.

In a preferred embodiment, measurements of a neckline are determined by identifying a pair of shoulders in the apparel image and further identifying an intersection of apparel item pixels and skin pixels in the vicinity of the identified pair of shoulders, wherein apparel item pixels are pixels of the apparel image that depict the apparel item, and skin pixels are pixels that depict human flesh, hair, mannequin material, or material other than the material of the apparel item. In this embodiment, the neckline of an apparel item is determined by identifying the outline of the intersection of apparel item pixels and skin pixels as the contour of a neckline. In another embodiment, the contour of a neckline is further classified by neckline type, wherein classifications of neckline types correspond to predetermined neckline shapes. These neckline shapes include for example v-neck, crew neck, u-neck, sweetheart, and turtleneck shapes. In another embodiment, support vector machine classifiers are learned for each neckline type. Alternatively, Ada-boost classifiers, linear classifiers, quadratic classifiers, logistic classifiers, neural network classifiers, probabilistic classifiers, or decision tree classifiers may also be used to learn different neckline types. In another embodiment, an ensemble of classifiers and regression methods may also be employed to make this prediction.

In another embodiment, the image processing unit 125 classifies the degree of conservativeness of an apparel item. In this embodiment, the conservativeness of an apparel item may be determined by calculating a combination of preliminary apparel dimensions including skirt length, the distance between the top of the shoulders to a bottom point on a neckline, the bare length of a leg, and a normalized area of skin exposed by the apparel item. The normalized area of skin exposed by an apparel item may be calculated by first calculating the area of skin exposure by summing all the skin pixels depicted in the apparel image foreground. This area of skin exposed may then be normalized by expressing this area in terms of a normalization length squared. Alternatively, the image processing unit 125 calculates the area of skin exposed by an apparel item by approximating the area of a whole body and subtracting from this area the number of pixels that depict the apparel item. This type of embodiment is useful for calculating skin exposure when a whole humanoid figure is not represented in an apparel image, such as when portions of a human model have been cropped out of the picture, or when the apparel image depicts only a partial mannequin representing less than a whole body. In one embodiment of this type, the area of a whole body is approximated by identifying an anatomical structure, calculating the area of the anatomical structure by summing all of the pixels representing the anatomical structure, and multiplying this value by a constant that represents the statistical proportional area of the identified anatomical structure to a human body. For example, if the area of a torso depicted in an apparel image is displayed by 1,000 pixels, the area of a whole body may be approximated by multiplying this value by 3. Alternatively, the area of a whole body may be approximated by measuring the length of an anatomical structure, squaring the length of the anatomical structure, and multiplying the squared length of the anatomical structure by a constant. For example, in one embodiment, if the length between a pair of shoulders is measured to be 100 pixels, the area of the entire human figure may be approximated by squaring the shoulder length of 100 pixels (=1,000 pixels), and multiplying this area by 3.

In a preferred embodiment, the image processing unit 125 records the normalized apparel dimension determined in step 1407 in a database. In another preferred embodiment, the normalized apparel dimension determined in step 1407 is compared with a normalized apparel dimension of a second apparel item, wherein the normalized apparel dimension of both the second apparel item and the normalized apparel dimension determined in step 1407 are both expressed in terms of the same normalization variable. For example, in one embodiment, both normalized apparel dimensions are expressed in terms of shoulder lengths. In another embodiment, the normalized apparel dimensions are standardized to represent life-sized scaled measurements. For example, if a normalized dress length is expressed in shoulder lengths as 3 shoulder lengths, then a standardized dress length may be calculated by multiplying this value by the standardizing constant of 1.5 ft/shoulder length.

FIG. 15 illustrates a method 1500 of comparing the visual characteristics of an electronic image with electronic images represented by data stored in a database, storing the electronic image in the database, and then reorienting the database to account for the new image. In a preferred embodiment, the visual characteristics of an electronic image are compared to visual characteristics of each image stored in the database 115A, wherein the database 115A contains the visual characteristics of a plurality of electronic images. At step 1501, the image processing unit 125 retrieves image data, including visual characteristics, of an image that is to be stored in the database 115A. In a preferred embodiment of the invention, this data also includes text based data representative of the image, and other data obtained by the data retrieval unit 140. The image that is compared to images represented in the database 115A is referred to as the query image. In a preferred embodiment, the image characteristics are represented by histograms determined in accordance to the method of FIG. 12.

The image processing unit 125 then retrieves image data representative of an image stored in the database 115A in step 1502. In the preferred embodiment of the invention, this data includes any text based data stored as metadata in the database 115A, such as data representative of the visual characteristics, any text based data, and image category. The respective image is referred to as the target image.

The image processing unit 125 then proceeds to step 1503A and determines whether the query image and the target image are of the same category. The image processing unit 125 performs this step by comparing metadata representative of the query image category with data representative of the target image category stored as metadata in database 115A. When the image processing unit 125 determines that data representative of the category of the target image and the query image are different, such that the query image and target image depict different objects, the image processing unit 125 determines the color difference of the query image and the target image in step 1504B. The image processing unit 125 does this in accordance to the method of FIG. 10. When the image processing unit 125 determines that the category of the metadata associated with the target image and the query image are the same, the image processing unit determines if the query image and target images are solid in steps 1503B and 1503C, respectively. This step is performed in accordance to the method of FIG. 3. If the target and query images are solid then the imaging processing unit goes to step 1504B. If the target and query images are not solid, then step 1504A is followed by the imaging processing unit 125 to determine the weighted pattern and color difference of the query image and the target image.

In an alternative embodiment, the image processing unit performs steps 1503A, 1503B, 1503C in another order, or performs two or more steps simultaneously in any order. If the image processing unit proceeds to step 1504B and determines the color difference between the query image and the target image, the image processing unit 125 stores the color difference as metadata associated with the query image and the target image in the database 115A in step 1505. When the processing unit 125 determines that the query image and the target image are associated with the same category of images and neither is solidly colored, the image processing unit proceeds to step 1504A and determines the weighted color and pattern difference of the query object and the target object. The image processing unit determines the weighted color and pattern difference in accordance to the method of FIG. 13. When the image processing unit 125 determines the weighted color and pattern difference of the query image and the target image, the image processing unit stores data representative of the difference in the database 115A as metadata associated with the two images in step 1505.

The image processing unit 125 then determines if the query image has been compared to all target images represented in the database 115A in step 1506. When the image processing unit 125 determines that all target images stored in the database 115A have not been compared to the query image, the image processing unit 125 returns to step 1502 and retrieves data representative of a target image that has not been compared to the query image. In a preferred embodiment of the invention, the data representative of target images are stored in the database unit 115A with metadata associated with a target image numerical value. The image processing unit 125 runs a counter program that marks each numerical value of a target image when the respective target image is compared to the query image. For example, 150 target images could be represented by data stored in the database 115A. Each of the target images is associated with a numerical value, 1-150, and no target image is associated with the same numerical value. The image processing unit 125 could compare the query image to target images in ascending order, such that the image processing unit 125 would compare the query image to the target image associated with numerical value 1, then the target image associated with the numerical value 2, and so on. Once the processing unit 125 compares the query image to the target image associated with the numerical ID 150, the processing unit 125 would stop looping back to step 1502. Alternatively, the image processing unit could retrieve the number of target images, N, represented in the database 115A and mark how many times the image processing loops back to step 1502. Once the image processing unit 125 marks that the loop to step 1502 has been performed N−1 times, the image processing unit 125 would then stop looping to step 1502.

Once the image processing unit 125 has compared the query image to all of the target images, the image processing unit 125 goes to step 1507 and ranks the metadata representative of the differences between the query image and each target image stored in the database 115A. After the image processing unit 125 has ranked the metadata, the image processing unit 125 determines which target images are image matches with the query image in step 1508 and then saves the matches in memory in step 1509. The image processing unit 125 determines matches by grouping the target images having the least difference with the query image. The number of matches in the grouping corresponds to a predetermined value stored in the processing memory unit 130. For example, the size of the grouping may be defined as the 50 target images having the least difference value with the query image. In this case, these 50 target images are stored as match metadata associated with the query image in the database 115A. In one preferred embodiment, once the query image has been assigned 50 target image matches in the database 115A, the matches associated with the target images are also altered. In one embodiment, the image processing unit 125 recalculates the matching images of each target image stored in the database, such that the images that are matches with the target image as metadata are the predetermined number of images having the least differences with the target image when the query image has been applied to the target images and represented in the database as an additional target image. Alternatively, the image processing unit 125 defines the set of matches in terms of a fraction of all of the target images stored in the database. For example, the image processing unit 125 could assign matches to a query image by determining the top 25% of target images having the least differences with the query image. If 100 target images are stored in the database 115A, the image processing unit 125 would assign the 25 target images having the least difference with the query image as match metadata and store this in the database 115A.

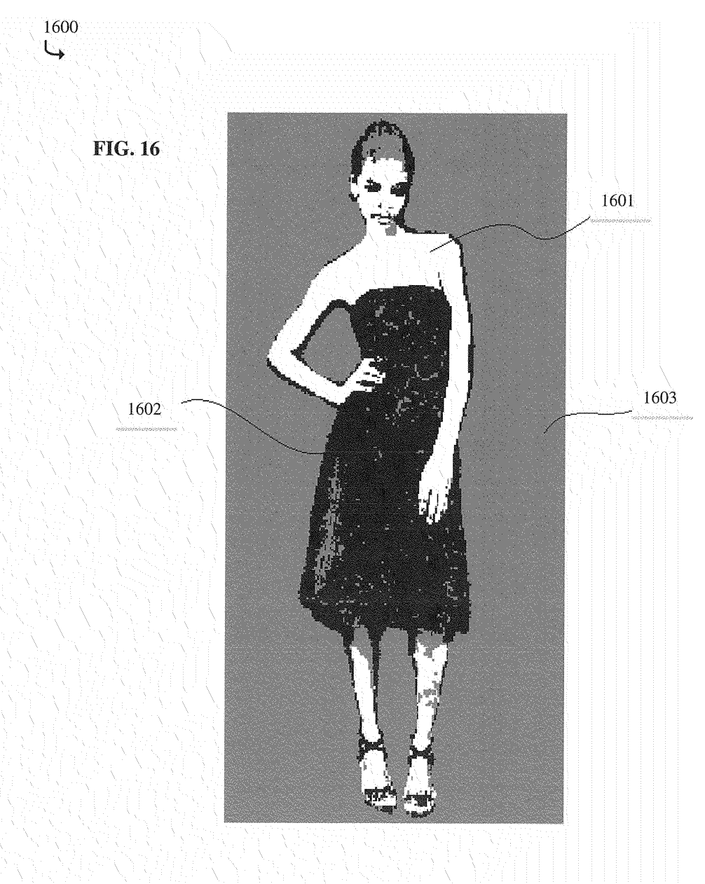

FIG. 16 illustrates a segmented electronic image 1600 according to one embodiment. The segmented apparel image 1600 is a visual representation of an electronic image 522 segmented into pixel classification types. The electronic image 1600 includes pixels that are classified as skin pixels 1601, pixels that are classified as apparel foreground pixels 1602, and pixels that are classified as background pixels 1603. The processing of an electronic image into classifications of skin pixels 1601, foreground pixels 1602, and background pixels 1603 is detailed by the flow chart of FIG. 4, for example.

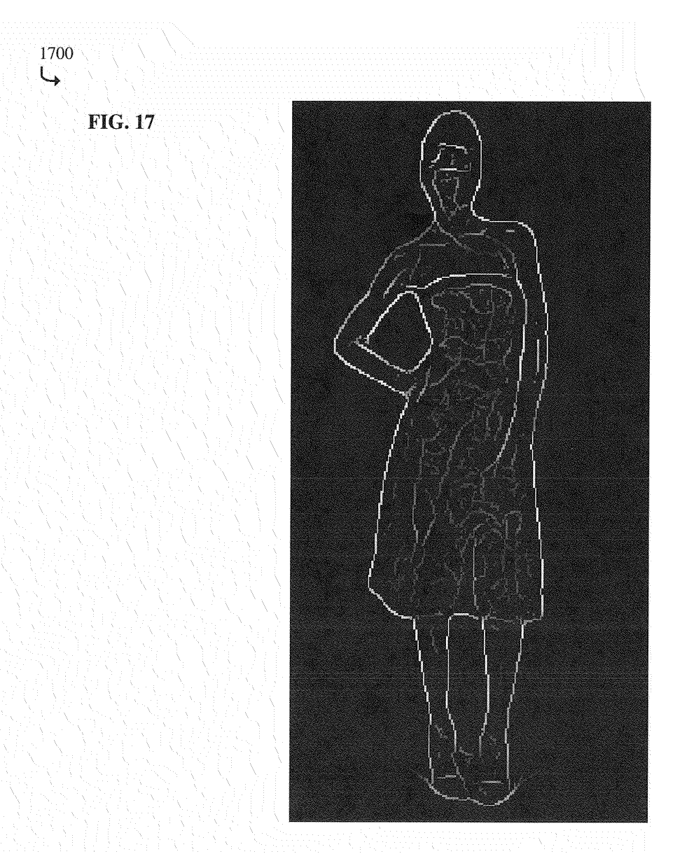

FIG. 17 illustrates an edge detection image 1700 according to one embodiment. The edge detection image 1700 is a visual representation of edges detected in an image 522. The process of detecting edges in an image is described in step 810 of the flow chart of FIG. 8, for example.

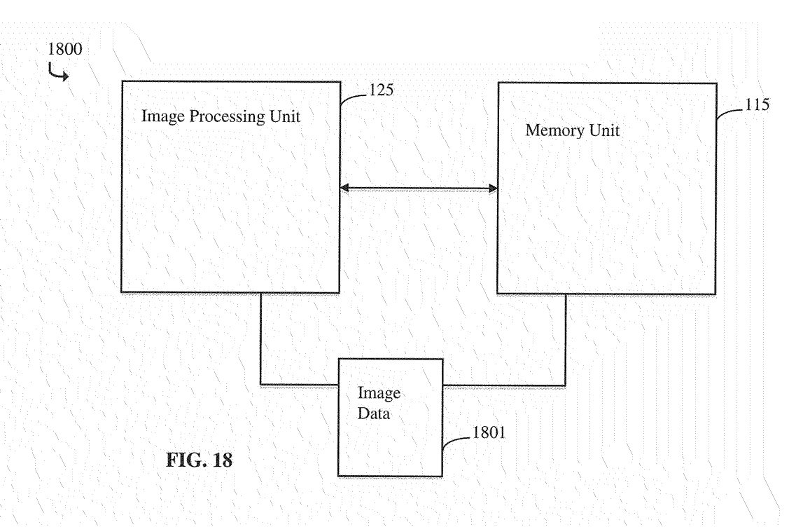

FIG. 18 illustrates an image segmenting system 1800 according to one embodiment. The image segmenting system 1800 includes an image processing unit 125, a memory unit 115, and data representative of an image 1801. The electronic image 1801 is preferably an apparel item. The apparel item may include clothing such as shoes, handbags, or dresses.

In the image segmenting system 1800 the image is stored in the memory unit 115. The memory unit 115 is in bidirectional communication with the image processing unit 125. The memory unit 115 transmits the data representative of the image 1801 to the image processing unit 125.

In operation, the image processing unit 125 receives the data representative of the image 1801 from the memory unit 115. Alternatively, the image processing unit receives the data representative of the image from the data retrieval unit 140 from the system of FIG. 1. Alternatively, the image processing unit 125 receives data representative of the image 1801 from the processor memory unit 130 of the system of FIG. 1. After receiving data representative of the image 1801, the image processing unit 125 segments the image by classifying pixels as skin pixels, foreground pixels, or background pixels. The process of segmenting the image is illustrated by the flow chart of FIG. 4, for example.

In a preferred embodiment, the memory unit 115 is in bidirectional communication with the image processing unit 125. In this embodiment, the image processing unit 125 sends a signal to the memory unit 115, whereby the memory unit 115 responds by sending a signal representative of the image to the image processing unit 125. In another preferred embodiment, the image processing unit 125 communicates remotely with the memory unit 115. In this embodiment the communication may be conducted over an internet connection through a server. The communication between the image processing unit 125 and the memory unit 115 may also be conducted through radio signals. In another embodiment, communication may be conducted locally by connecting the memory unit 115 and the image processing unit 125 directly by a data cable such as a USB, USB 2.0, mini USB, FireWire 400, FireWire 800, or other data cable connection. Alternatively, the memory unit 115 may comprise one or more portable recordable media for storing data representative of the image 1801. In this embodiment the portable recordable media may be received directly by the image processing unit 125. In another embodiment, the memory unit 115 consists of a plurality of servers hosting web content. In such an embodiment, the memory unit 115 encompasses servers hosting web content of e-commerce internet sites. In another embodiment, the image processing unit 125 may include only one computer that performs the process of segmenting the image. In another embodiment, the image processing unit 125 may include a plurality of computers that collectively perform the process of segmenting the image.

### INDUSTRIAL APPLICABILITY

The present disclosure relates to systems and methods for comparing images of items. The systems and methods allow a consumer of an apparel item to find a similar apparel item by querying a database through a website.

Numerous modifications to the present invention will be apparent to those skilled in the art in view of the foregoing description. Accordingly, this description is to be construed as illustrative only and is presented for the purpose of enabling those skilled in the art to make and use the invention and to teach the best mode of carrying out same. The exclusive rights to all modifications which come within the scope of the appended claims are reserved.

We claim:

1. A method of comparing electronic images utilizing an image processing unit, the method comprising the steps of:
determining query data representative of a query image utilizing an image processing unit, wherein the query image depicts a query object and the query data includes data representative of spatial and color features of the query object;
accessing a database that stores target data representative of target images that depict target objects, wherein the target data includes data representative of spatial and color features of the target object;
processing the query data and the target data to determine characteristic data representative of a weighted shape and a weighted color of the query object and the target objects; and
determining differences in the characteristic data of the query object and target objects.

2. The method of claim 1, further comprising the steps of partitioning the query image and the target images into pixel sections that include a foreground pixel segment, a humanoid model pixel segment, or a background pixel segment and isolating pixels that represent the query and target objects.

3. The method of claim 1, further comprising the steps of ranking the differences in the characteristic data between the query object and the target objects and determining a set of matches to the query object, wherein the set of matches includes target images having the least weighted difference from the query image.

4. The method of claim 1, wherein the spatial features include a histogram of oriented gradients representative of at least one of a contour shape and an inner shape of the object.

5. The method of claim 1, further comprising the step of normalizing angles of the query and target images before performing the processing step.

6. The method of claim 1, further comprising the step of normalizing sizes of the query and target images, wherein the size of the query object is representative of the size of the target object.

7. The method of claim 1, further comprising the steps of retrieving data representative of the class of the query object and comparing the class of the query object to the class of a target object.

8. The method of claim 7, further comprising the step of determining a difference in only the weighted color between the query object and the target object if the class of the query object is different than the class of the target object.

9. The method of claim 7, further comprising the step of determining a difference in the weighted shape and the weighted color between the query object and the target object if the class of the query object is the same as the class of the target object.

10. The method of claim 1, wherein the step of determining differences in the characteristic data includes the steps of determining an earth mover's distance between histograms representative of color features of the query object and the target objects and determining an earth mover's distance between histograms representative of spatial features of the query object and the target objects.

11. The method of claim 1, further comprising the step of determining if the query object and target objects comprise patterned objects.

12. The method of claim 11, further comprising the step of determining a difference in a weighted pattern and weighted color between the query object and a target object if the query object and the target object are patterned objects.

13. The method of claim 11, further comprising the step of determining a difference in only the weighted color between the query object and a target object if the query object is not patterned.

14. The method of claim 1, wherein the step of determining differences in the characteristic data includes the steps of summing a weighted histogram of oriented gradients of an inner shape of the object, a weighted histogram of oriented gradients of a contour shape of the object, and a weighted histogram representative of points in color space of the object.

15. The method of claim 14, wherein the weighted histograms are pyramid histograms.

16. A method of comparing visual characteristics of electronic images utilizing a particular image processing unit, the method comprising the steps of:
determining a set of apparel item classes;
determining data representative of a query apparel image and a target apparel image, wherein the data includes a class of the query apparel image and a class of the target apparel image;
determining pattern features of the query apparel image and the target apparel image; and
determining only color differences between the query apparel image and the target apparel image when the query apparel image is not patterned or when the class of the query apparel image is different than the class of the target apparel image.

17. The method of claim 16, further comprising the step of determining color and pattern differences between the query apparel image and the target apparel image when the images are patterned and grouped in the same class.

18. The method of claim 16, wherein the step of determining pattern features of the query apparel image further includes the steps of determining a threshold pattern strength, wherein the threshold pattern strength is representative of a pattern similarity of a plurality of images, applying a plurality of pattern filters on a sampled portion of the query apparel image, wherein the plurality of pattern filters are representative of a plurality of patterns, and determining when a pattern strength of the pattern filter applied to the sampled portion is greater than the threshold pattern strength.

19. An image comparison system, comprising:
a memory unit storing data representative of target apparel images that depict apparel items; and
an image processing unit to process a query apparel image to extract data representative of a query apparel item depicted in the query apparel image and to determine weighted color and pattern differences between the target apparel images and the query apparel image.

20. The image comparison system of claim 19, further comprising a server unit in communication with a web crawler, wherein the web crawler retrieves data representative of the query image from the Internet and transmits the data to the image processor unit through the server unit.

21. A method of determining a plurality of pattern filters, the method comprising the steps of:
receiving a plurality of sampled pattern vectors by an image processing unit, wherein the sampled pattern vectors comprise a plurality of vectors representative of surrounding point intensities of sampled points of a plurality of images;
processing the plurality of sampled pattern vectors utilizing an image processing unit, wherein the image processing unit determines pattern filter vectors representative of the centroids of vector clusters of the sampled patterns vectors; and
storing data representative of the pattern filter vectors in a memory unit utilizing the image processing unit.

22. The method of claim 21, further comprising the steps of:
retrieving data representative of a sampled target vector utilizing an image processing unit, wherein the sampled target vector comprises a vector representative of surrounding point intensities of a target point of a target image; and
determining a convolution of the sampled target vector with a pattern filter vector utilizing an image processing unit; and
storing data representative of the convolution in a memory unit.

23. The method of claim 21, wherein the step of processing the plurality of sampled pattern vectors includes the step of processing the sampled pattern vectors by k means clustering.
